(19) United States
(12) Patent Application Publication
(10) Pub. No.: US 2012/0214572 A1
(43) Pub. Date: Aug. 23, 2012

(54) GAMING DISPLAY WITH MOVABLE INDICATOR AND METHODS OF USE

(76) Inventors: Jerald C. Seelig, Galloway, NJ (US); Lawrence M. Henshaw, Hammonton, NJ (US)

(21) Appl. No.: 13/399,124

(22) Filed: Feb. 17, 2012

Related U.S. Application Data
(63) Continuation-in-part of application No. 11/847,179, filed on Aug. 29, 2007.
Application No. 11/847,179 is a continuation-in-part of application No. 10/806,636, filed on Mar. 23, 2004, now Pat. No. 7,731,583.
Application No. 10/806,636 is a continuation-in-part of application No. 10/309,736, filed on Dec. 3, 2002, now abandoned.
Application No. 10/309,736 is a division of application No. 09/894,198, filed on Jun. 27, 2001, now Pat. No. 6,537,152.
(60) Provisional application No. 61/542,163, filed on Oct. 1, 2011.
(60) Provisional application No. 61/523,629, filed on Aug. 15, 2011.
(60) Provisional application No. 61/443,995, filed on Feb. 17, 2011.

(51) Int. Cl. A63F 13/00; A63F 5/00

(52) U.S. Cl. 463/20; 273/138.1

(57) ABSTRACT

A gaming apparatus includes a reel assembly having a frame. The frame has a first end and a second end. A driven reel is coupled to the first end and an idler is coupled to the second end. A reel band is coupled to the driven and idler reels. The reel band has a display surface. Several indicia are located on the display surface. An actuator is mounted to the frame and is coupled to the driven reel. The actuator is configured to move the reel band. A gaming method using the reel assembly is also disclosed.

### CROSS REFERENCES TO RELATED AND CO-PENDING PATENT APPLICATIONS

This application claims priority to U.S. provisional patent application Ser. No. 61/542,163 filed Oct. 1, 2011 entitled “Gaming Display With Movable Indicator and Methods of Use” and to U.S. provisional patent application Ser. No. 61/523,629 filed Aug. 15, 2011 entitled “Gaming Display With Movable Indicator and Methods of Use” and to U.S. provisional patent application Ser. No. 61/443,995 filed Feb. 17, 2011 entitled “Gaming Display With Movable Indicator and Methods of Use”, which is a continuation-in-part application of U.S. patent application having Ser. No. 11/847,179, filed Aug. 29, 2007 entitled “Gaming Display With Movable Indicator and Methods of Use”, which is a continuation-in-part application of U.S. patent application having Ser. No. 10/806,636, filed Mar. 23, 2004 entitled “Gaming Display With Movable Indicator and Methods of Use”, which is a continuation-in-part application of U.S. patent application having Ser. No. 10/309,736, filed Dec. 3, 2002, entitled “Gaming Device With Animated Figure” which is a divisional application of U.S. Pat. No. 6,537,152 to Seelig et al., which issued on Mar. 25, 2003. The contents of which are herein incorporated by reference in entirety.

### FIELD OF THE INVENTION

The present invention relates to gaming devices and, more particularly, to a gaming device having at least one movable indicator that indicates a prize to a player.

### BACKGROUND

Gaming devices are well known in the art, and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

One of the problems associated with the devices disclosed in these references is that the outcome of the bonus game is communicated to the player almost immediately. When a bonus game is triggered, a bonus award is selected, displayed, and awarded to the player. The player can see what the outcome of the game is immediately after the pointers have stopped moving. What has long been needed is a device that utilizes intermediate steps between the occurrence of the bonus event and the awarding of the bonus prize to add an additional element of anticipation and excitement for the players. It is further desired that the intermediate steps involve an eye-catching display. Another problem associated with Adams and Baerlocher et al. is that they utilize a plain combination of wheel and pointer. The applicants have discovered more things that can be done to display devices to make them more attractive and interesting to play.

Generally, bonus prizes are awarded in order to increase the excitement and enjoyment experienced by players, which attracts more players to the game and encourages players to play longer. When this occurs, the gaming devices tend to be more commercially successful relative to other gaming devices. A shortcoming of present bonus games is that they do not sufficiently allow players to interact with the gaming device, including during bonus games.

Other attempts have been made to provide player interaction. U.S. Pat. No. 5,788,573 to Baerlocher et al. (hereinafter, “Baerlocher”) purports to suggest a gaming device with an electronic “wheel of fortune game.” Several flippers appear to indicate positions on the wheel. Baerlocher appears to suggest that the player may be allowed to choose which flipper is used to select an indicium on the wheel. The player, however, does not appear to have any control over the position of the flipper and the flippers do not appear to be capable of moving to different positions.

U.S. Pat. No. 6,309,300 to Glavich (hereinafter, “Glavich”) and U.S. Pat. No. 6,439,995 to Hughs-Baird et al. (hereinafter, “Hughs-Baird”) purport to suggest a gaming system having a bonus feature where a player may be allowed to select a number of selectable items, which may be prize representations, on a video display. Glavich and Hughs-Baird do not appear to suggest using prize indicators, movable prize indicators, or allowing a player to position a prize indicator.

### SUMMARY

### Advantages

The various embodiments of the present invention may, but do not necessarily, achieve one or more of the following advantages:

provide a highly attractive and entertaining device for conducting games;

provide a highly attractive and entertaining device for displaying prizes;

the ability to attract more patrons to play a game;

the ability to encourage players to play longer on a gaming apparatus;

provide at least one attractive prize indicator;

provide a touch sensitive display in front of several moving belts;

allow a game player to select one or more pay lines;

provide a flexible band or belt that can display game indicia;

provide a moving belt that contains indicia;

provide several moving belts that can display a game outcome;

allow players to select belts to be moved;

provide a moving display surface;

provide a moving display with a relatively long path length;

provide a display that allows for a relatively larger number of indicia to be displayed;

provide a display that allows for relatively larger indicia to be displayed;

creates additional suspense for players by increasing the length of time between the start of a game and the display of the game outcome;

allow players to control the movement of a moving display surface;

provide the illusion that the player can influence the outcome of a game;

provide a game that allows for more player interaction;

utilize intermediate steps between the occurrence of the bonus event and the awarding of the bonus prize;

provide an additional element of anticipation and excitement for players;

provide a reel band assembly that displays a large number of indicia;

provide a reel band that has a driven reel and an idler reel;

provide a reel band that can be backlit by a light assembly; and

provide a reel band that can adjust the tension of the reel band using a tensioning assembly; and

These and other advantages may be realized by reference to the remaining portions of the specification, claims, and abstract.

### BRIEF DESCRIPTION OF CERTAIN ASPECTS OF THE INVENTION

In an embodiment, the present invention comprises a gaming apparatus that includes a reel assembly having a frame. The frame has a first end and a second end. A driven reel is coupled to the first end and an idler is coupled to the second end. A reel band is coupled to the driven and idler reels. The reel band has a display surface. Several indicia are located on the display surface. An actuator is mounted to the frame and is coupled to the driven reel. The actuator is configured to move the reel band. A gaming method using the reel assembly is also disclosed.

In another embodiment, the present invention comprises a gaming method. The method includes allowing a player to place a wager and determining a game outcome. Several reel bands are moved by rotating a driven reel coupled to each reel band. Each of the reel bands has a display surface and each of the display surfaces has several indicia mounted thereon. The reel bands are stopped and set of the indicia are indicated as the game outcome.

In one embodiment, the present invention comprises a gaming apparatus that includes several reel assemblies positioned adjacent each other. Each of the reel assemblies has a reel band that is coupled to a driven reel. Each of the reel bands has a display surface. Several indicia are disposed on each of the display surfaces. An actuator is coupled to each of the driven reels. A controller is in communication with the actuators. The controller is configured to determine a game outcome and to move the reel bands. The controller is further configured to stop the reel bands and such that a set of the indicia form a game outcome.

In one more embodiment, the present invention comprises a gaming apparatus that includes reel band means for displaying a plurality of indicia and reel means for supporting the reel band means for rotating movement. Actuator means move the reel band means. The actuator means are coupled to the reel means. Controller means control the actuator means. The controller means are in communication with the actuator means. The controller means are configured to move the reel band means such that at least one of the indicia convey a game outcome.

In another embodiment, the present invention comprises a gaming method. The method includes determining a game outcome and moving a plurality of belts. The belts have a display surface. The display surface has a plurality of indicia. The belts are stopped and a game outcome is indicated by a set of the indicia.

In an additional embodiment, the present invention comprises a gaming apparatus that includes a plurality of belts that have a plurality of indicia disposed thereon. Several positioning mechanisms are coupled to the belts. A controller is in communication with the positioning mechanisms. The controller directs the positioning mechanisms to position each of the belts such that at least one of the indicia convey a game outcome.

In yet another embodiment, the present invention comprises a gaming apparatus that includes a means for displaying a plurality of indicia, means for moving the plurality of indicia, means for determining a game outcome, means for stopping the plurality of indicia and means for indicating the game outcome.

In one more embodiment, the present invention comprises a gaming apparatus that includes a plurality of movable belts. The belts have a display surface with indicia disposed on the display surface. Actuators are coupled to the movable belts. A controller is in communication with the actuators. The controller determines a game outcome, moves the belts and stops the belts such that a set of the indicia form a game outcome.

In an additional embodiment, the present invention comprises a gaming apparatus that includes a gaming device having a video display and a gaming device having a mechanical display. A server is in communication with the gaming devices. Software operates on the server to provide a progressive jackpot award. The software uses a common progressive paytable for the gaming devices.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Certain embodiments of the invention are shown in the accompanying drawings wherein:

FIG. 1a is substantially a front elevation view of an embodiment of the gaming apparatus of the present invention.

FIG. 1b is substantially a schematic diagram showing components of an embodiment of the gaming apparatus.

FIG. 2a is substantially a partial perspective view of an embodiment of a display device of a prize display.

FIG. 2b is substantially a perspective view of the display device shown in FIG. 2a with a band on which indicia are affixed.

FIG. 3 is substantially a side elevation view of one embodiment of a positioning mechanism of the present invention.

FIG. 4 is substantially a partial cross-sectional view of the gaming apparatus of FIG. 1a.

FIG. 5 is substantially a front elevation view of an embodiment of a gaming apparatus of the present invention.

FIG. 6 is substantially a flowchart of a gaming method of the present invention.

FIG. 7 is substantially a front perspective view of an embodiment of a gaming apparatus of the present invention.

FIG. 8 is substantially a side elevation view of an embodiment of a gaming apparatus according to the present invention.

FIG. 9 is substantially a front view of a gaming apparatus according to the present invention, including a cut away view showing the interior of the gaming apparatus.

FIG. 10 is substantially a flowchart of a method according to the present invention.

FIG. 11 is substantially a flowchart of a method according to the present invention.

FIG. 12 is substantially a flowchart of a method according to the present invention.

FIG. 13 is substantially a flowchart of a method according to the present invention.

FIG. 14 is substantially a flowchart of a method according to the present invention.

FIG. 15 is substantially a front view of another embodiment of a gaming apparatus according to the present invention.

FIG. 16 is substantially a perspective view of the gaming apparatus of FIG. 15 with the housing removed.

FIG. 17 is substantially a partial cross-sectional view of the gaming apparatus of FIG. 15.

FIG. 18 is substantially a flowchart of a gaming method according to the present invention using the apparatus of FIGS. 15-17.

FIG. 19 is substantially a front view of another embodiment of a gaming apparatus according to the present invention.

FIG. 20 is substantially a perspective view of the gaming apparatus of FIG. 19 with the housing removed.

FIG. 21 is substantially a diagrammatic view of the gaming apparatus of FIG. 19 showing the apparatuses connected with a controller.

FIG. 22 is substantially a flowchart of a gaming method according to the present invention using the apparatus of FIG. 19.

FIG. 23 is substantially a front view of another embodiment of a gaming apparatus according to the present invention.

FIG. 24 is substantially a front view of another embodiment of a gaming apparatus according to the present invention.

FIG. 25 is substantially a perspective view of the gaming apparatus of FIG. 24 with the housing removed.

FIG. 26 is substantially a side elevation view of the gaming apparatus of FIG. 24 with one side of the housing removed.

FIG. 27 is substantially an enlarged view of the gaming apparatus of FIG. 26 showing details of the belt tensioning assembly.

FIG. 28 is substantially a flowchart of a gaming method according to the present invention using the gaming apparatus of FIG. 24.

FIG. 29 is substantially a flowchart of a gaming method according to the present invention using the gaming apparatus of FIG. 24.

FIG. 30 is substantially a front view of another embodiment of a gaming apparatus according to the present invention.

FIG. 31 is substantially a front view of another embodiment of a gaming apparatus according to the present invention.

FIG. 32 is substantially a flowchart of a gaming method according to the present invention using the gaming apparatus of FIG. 30.

FIG. 33 is substantially a flowchart of a gaming method according to the present invention using the gaming apparatus of FIG. 31.

FIG. 34 is substantially a perspective view of an embodiment of a reel band assembly.

FIG. 35 is substantially a rear side view of the reel band assembly of FIG. 34.

FIG. 36 is substantially an exploded view of the reel band assembly of FIG. 34 with the housing removed.

FIG. 37A is substantially a perspective view of the reel band assembly of FIG. 34 with the housing removed.

FIG. 37B is substantially a diagrammatic view of a gaming apparatus using the reel band assembly of FIG. 34.

FIG. 37C is substantially a front view of the gaming apparatus of FIG. 37B with a portion of the housing removed.

FIG. 38 is substantially an exploded view of an embodiment of a light assembly.

FIG. 39 is substantially a diagrammatic view of a progressive gaming system in accordance with the present invention.

FIG. 40 is substantially a flowchart of a gaming method according to the present invention using the progressive gaming system of FIG. 39.

### DESCRIPTION OF AT LEAST ONE EMBODIMENT OF THE PRESENT INVENTION

In the following detailed description of at least one embodiment of the present invention, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

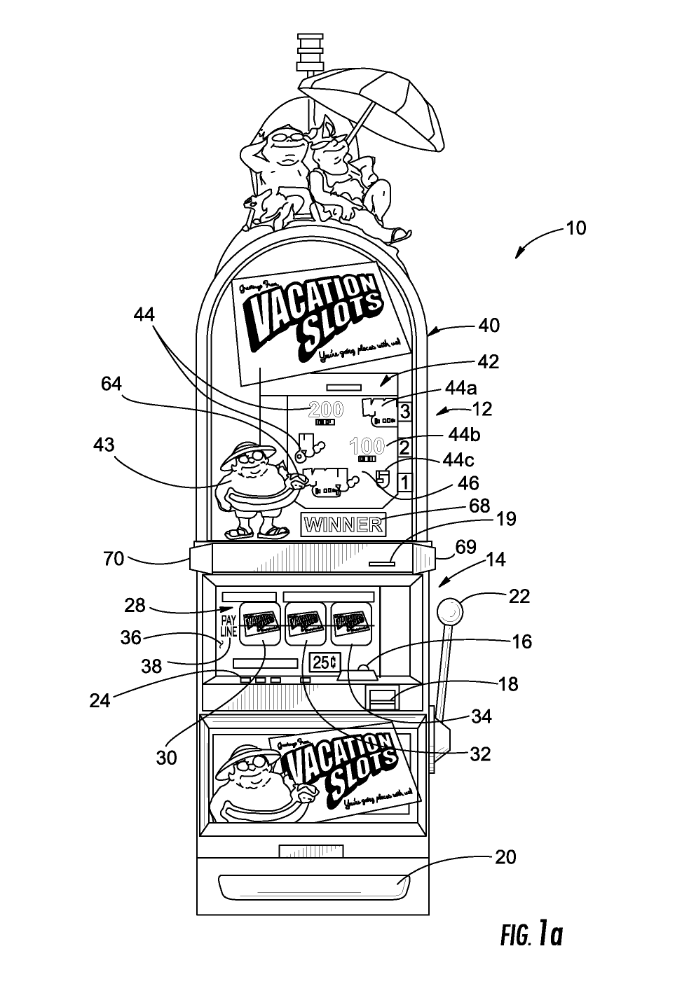

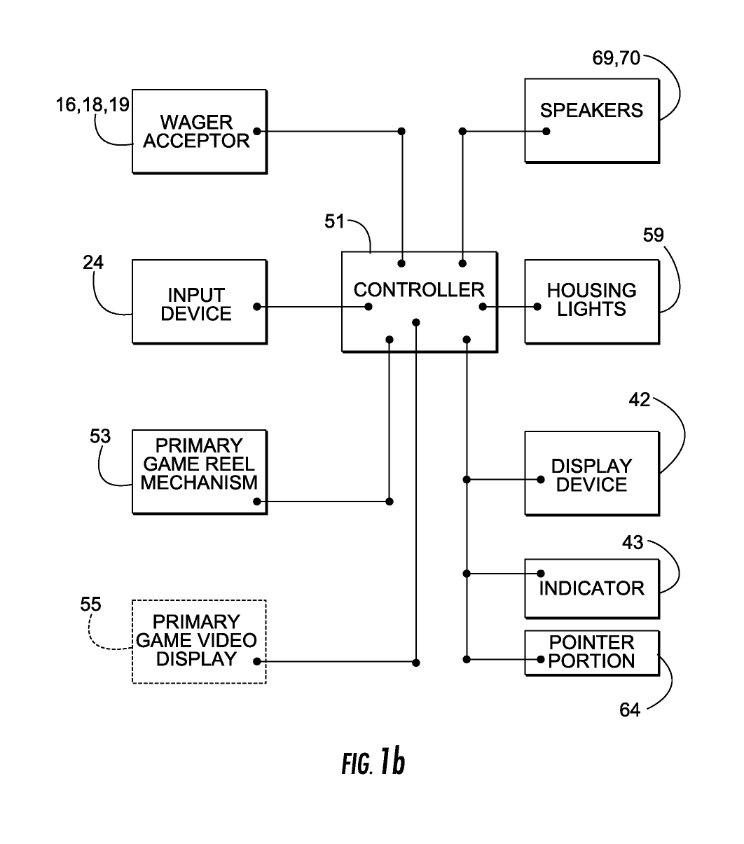

As seen in FIG. 1a, the present invention comprises a gaming apparatus, generally indicated by reference number 10. In at least one embodiment, gaming apparatus 10 comprises a second display 12 and a primary gaming device 14. Gaming device 14 may be any of a large number of devices that are adapted to allow players to play a game, such as gaming devices typically found in arcade and casino environments, including arcade games, video games, gambling machines, video poker machines, slot machines, etc. In at least one embodiment, gaming device 14 is further adapted to allow a player to place a wager and play a game, such as a slot machine.

Gaming device 14 may include a value or wager acceptor for accepting value (including currency and/or currency equivalents), such as a coin slot 16, card reader 18, or a voucher reader 19. In addition, a payout mechanism (not shown) and a coin receptacle 20 may be provided for awarding prizes or for dispensing value to players cashing out and retiring from a game. A printer (not shown) may also be provided for printing out cashless vouchers (not shown). A handle 22 and an input device 24 may be provided for activating gaming device 14 to begin a game. A pay table (not shown) may further be provided to allow a player to see what symbol or combination of symbols provide a winning event. In at least one preferred embodiment, gaming device 14 may be a S2000 or S Plus model gaming device manufactured by International Game Technology in Reno, Nev.

Gaming device 14 may further include a gaming outcome display 28 that may be positioned in front of the gaming device 14 so that a player (not shown) playing gaming device 14 can see gaming outcome display 28. Gaming outcome display 28 may utilize physical game reels 30, 32, and 34. Game reels 30, 32, and 34 may be attached to a drive mechanism (not shown) of gaming device 14 to rotate the reels in a manner well known in the art. Each game reel 30, 32, and 34 may have a plurality of symbols positioned on the circumference of each game reel 30, 32, and 34. Game reels 30, 32, and 34 may be positioned side-by-side with coincident axes of rotation, and a portion of their individual circumferences may face outward from gaming device 14.

A panel 36 may cover game reels 30, 32, and 34 such that only a portion of their individual circumferences are shown to the player. At least one symbol from any of game reels 30, 32, and 34 may be used to display a game outcome. At least one pay line 38 may be provided for the player to use in determining a game outcome based on the symbol or a combination of symbols positioned thereon. In an alternative embodiment, gaming outcome display 28 utilizes a video display (FIG. 1b) displaying images of game reels and an image of at least one pay line. A video display may also display game symbols in many other formats and arrangements, such as playing cards. Of course, the invention is not limited to any particular type of gaming outcome display 28. Those of skill in the art will recognize that many different types of gaming outcome displays could be substituted without departing from the scope of the present invention.

Gaming apparatus 10 may include a bonus game display or second display 12 configured to display at least one game and prize to a player. In at least one embodiment, second display 12 is configured to display a bonus game and at least one bonus prize to the player. In other embodiments, second display 12 may provide a primary game. Alternatively, second display 12 may be a stand-alone device allowing a player to place a wager and play a game.

In at least one embodiment, second display 12 is attached to gaming device 14 and positioned on top of gaming device 14. In other embodiments (not shown), second display 12 may be separate from gaming device 14 but in communication with gaming device 14. In this embodiment, second display 12 may be in communication with a plurality of different gaming devices 14 via a computer network in a manner that is well known in the art. Second display 12 may also be positioned adjacent to or remote from gaming device 14. In other embodiments, second display 12 is a stand-alone display not in communication with gaming device 14, and it may be capable of independently accepting wagers, conducting games, and awarding prizes to a player.

With continued reference to FIG. 1a, second display 12 may comprise a housing 40. Housing 40 may be arc-shaped and comprise a plurality of walls defining an internal space or cavity. Of course, housing 40 may be made in many different shapes. Second display 12 also may have an indicator 43. Indicator 43 may be a variety of indicators, including two and three-dimensional indicators.

Indicator 43 and display device 42 may be positioned within housing 40. Indicator 43 may be configured to move vertically (up and down) relative to second display 12 in response to signals sent either by a controller (not shown) or a combination of an input device (not shown) and a controller (not shown). The number of indicators 43 may vary, and the direction of their movement may vary, and may include horizontal, zigzag, and/or diagonal movements.

The shape or appearance of indicator 43 may be designed in various forms and preferably according to a theme of a game. In the example shown in FIG. 1a, the theme of the game is a gaming device that awards players with vacations. Accordingly, indicator 43 is in the form of a vacationing person in a swimming outfit and in a swimming floatation tube. Indicator 43 may include a pointer portion 64. Pointer portion 64 may be configured to point to at least one indicium 44. Alternatively, indicator 43 may itself be a pointer, such as an arrow. The present invention is not limited to any particular type of indicator or pointer, or any particular representation of an indicator or pointer.

Indicia 44 may be affixed, imprinted, engraved, or otherwise represented on a display device 42. Display device 42 may have indicia 44 arranged in rows 44a-c. Each row 44a-c may include multiple indicia 44. Indicia 44 may represent various things, including prize amounts, multipliers, descriptions or representations of merchandise or services, progressive prizes, or jackpot prizes. In the embodiment shown in FIG. 1a, display device 42 is configured to present movable indicia 44, which may move in various directions. As shown in FIG. 1a, indicia 44 move horizontally, or on a rotational axis parallel to the vertical movement of indicator 43. Of course, indicia 44 could be configured to move up and down, that is, display device 42 may have a horizontal rotational axis.

Certain embodiments of the present invention may provide display devices 42 with indicia 44 moving on a first axis and an indicator 43 moving on a second axis, wherein the movable indicator 43 is able to indicate an indicium 44 on the display device, which may be configured to move on an axis orthogonal to the axis of indicator 43.

Referring now to FIG. 1b, a schematic diagram of some components that may be included in certain embodiments of gaming apparatus 10 (FIG. 1a) is shown. Gaming apparatus 10 may include a value or wager acceptor such as coin slot 16, card reader 18, and voucher reader 19, configured to accept value from the player in the form of paper currency, coins, player cards, tickets, vouchers, tokens, or other forms of value. Value acceptors 16, 18, and 19 may be in communication with a controller 51. Controller 51 may be in communication with an input device 24. Controller 51 may detect insertion of value into value acceptors 16, 18, and 19 and may prompt the player to start a game by activating input device 24. Once controller 51 senses a signal to start the game, controller 51 may be configured to produce a random number and activate reel mechanism 53 of gaming device 14. Reel mechanism 53 may be configured to display indicia (including symbols, characters, numbers, letters, pictures, and the like) on game reels 30, 32, and 34 according to the random number generated by controller 51. Alternatively, controller 51 may be configured to produce a random number and activate video display 55, displaying images of game reels on gaming device 14. The video display 55 may be configured to display indicia in video form according to the random number generated by controller 51. The primary game of gaming device 14, whether in physical form or in video form, is not limited to reel-type games, but may include card games, dominoes, roulette, craps, baccarat, and other games.

Gaming apparatus 10 may further include speakers 69 and 70, housing lights 59, display device 42, indicator 43, and pointer portion 64 in communication with controller 51. Controller 51 may store bonus event information and may have the ability to detect bonus events.

Upon an occurrence of a bonus event, controller 51 may activate speakers 69 and 70, housing lights 59, and display device 42, which causes indicia 44 to move. Controller 51 may cause indicator 43 to move around an area adjacent to display device 42. Controller 51 may then cause indicator 43 to stop, and pointer portion 64 to point to an indicium 44 on display device 42. Housing lights 59 and speakers 69 and 70 together may create a festive and lively winning atmosphere to elicit interest and entertainment from both the player and adjacent patrons.

In at least one embodiment, when gaming apparatus 10 is not in use, indicator 43, housing lights 59, and display speakers 69 and 70 may be activated by controller 51 in an attract mode. Housing lights 59 may operate, blink or flash, and indicator 43 may dance or move in a choreographed manner according to music coming from speakers 56. It may be desirable that indicator 43 not point to an indicium 44 at the conclusion of the attract mode in order that players close to gaming device 10 do not mistakenly believe they are entitled to a prize. Controller 51 may activate display device 42 and indicator 43 upon the occurrence of a bonus event.

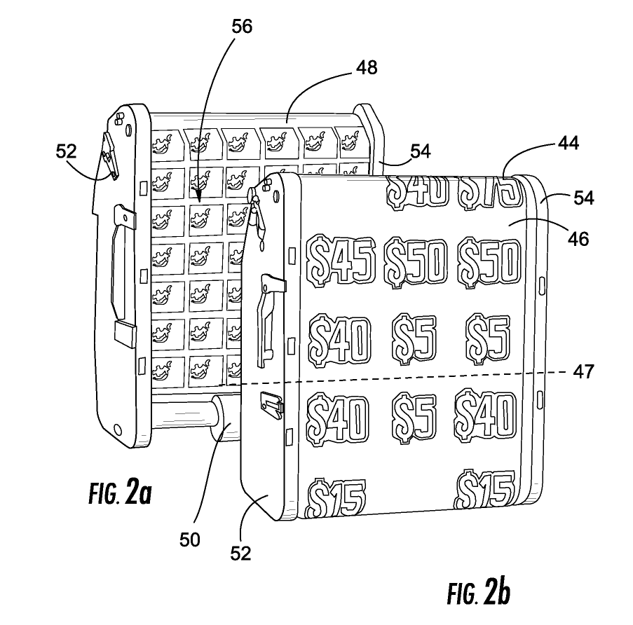

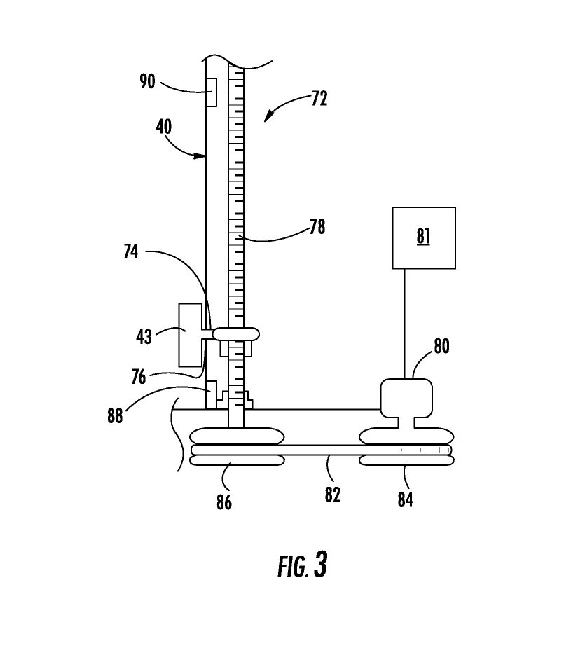

Referring now to FIGS. 2a and 2b, in at least one embodiment, display device 42 (FIG. 1a) comprises a flat piece of material or band 46 wrapped around a plurality of rollers 48 and 50. Rollers 48 and 50 rotate band 46 about an axis 47. Rollers 48 and 50 may be rotatably connected to chassis 52 and 54 and may be connected to an actuator (not shown). Band 46 has indicia 44 thereon. Indicia 44 may be affixed to band 46 by various methods. Indicia 44 may be imprinted on band 46 in different configurations depending on the desired appearance of indicia 44 when band 46 is presented on second display 12. In the embodiment shown in FIG. 1a, band 46 may move from left to right relative to second display 12 or vice-versa. Thus, indicia 44 are displayed in horizontal rows.

In at least one embodiment, a light matrix 56 is positioned behind band 46 to back-light indicia 44. Light matrix 56 may comprise light emitting diodes (LEDs), fluorescent lights, incandescent lights, or other illumination devices that may make band 46 more attractive. A suitable display device 42 may be obtained from Starpoint Electronics Ltd. of Chessington, UK (model FM2).

In another embodiment, display device 42 may comprise at least one conventional reel assembly (not shown). A conventional reel assembly typically includes at least one chassis, an axle attached to the chassis, and a reel attached to the axle. The reel and chassis are typically coupled to an actuator that drives the axle, thereby rotating the reel. The reel typically has a strip of material attached to the circumference of the reel. Indicia are typically affixed to the strip of material by methods known in the art. Conventional reel assemblies may be joined in series, typically in a set of three.

The reel assembly may be positioned within housing 40 (FIG. 1a) so that the reel rotates about either a horizontal or vertical axis. Display device 42 may utilize the reel assemblies described in co-pending U.S. application Ser. No. 09/894,197, filed Jul. 27, 2001, and U.S. application Ser. No. 09/968,952, filed Oct. 1, 2001, which are incorporated herein by reference. U.S. application Ser. No. 09/894,197 discloses reel shelf assemblies arranged vertically so that each reel rotates about a vertical axis. U.S. application Ser. No. 09/968,952 discloses reel shelf assemblies having reels that are positioned at an angle relative to each other, side-by-side so that their chassis are away from the two reels positioned adjacent to each other, or combinations thereof.

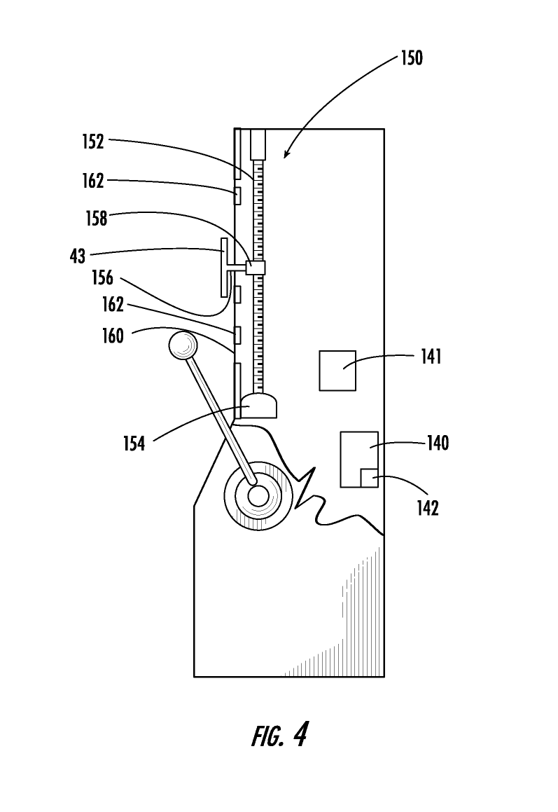

Referring now to FIG. 3, indicator 43 (FIG. 1a) may be coupled to a positioning mechanism 72 by a bracket 74. Positioning mechanism 72 may be located within the confines of housing 40. A slot 76 in the front wall of housing 40 may be provided, which allows bracket 74 to pass through the front wall. Positioning mechanism 72 may comprise a worm gear 78 rotatable by an actuator 80. In at least one embodiment, actuator 80 is attached to a first wheel 84. Worm gear 78 may be attached to a second wheel 86. A drive belt 82 preferably rotates around the first wheel 84 and second wheel 86, thereby connecting actuator 80 and worm gear 78. Positioning mechanism 72 may communicate with a controller 81, which may store information regarding pre-determined positions of band 46 of display device 42. Sensors 88 and 90 are preferably in communication with controller 81 and may be provided to allow controller 81 to detect the position of indicator 43. Other devices may be used to detect the position of indicator 43, such as optical readers and the like.

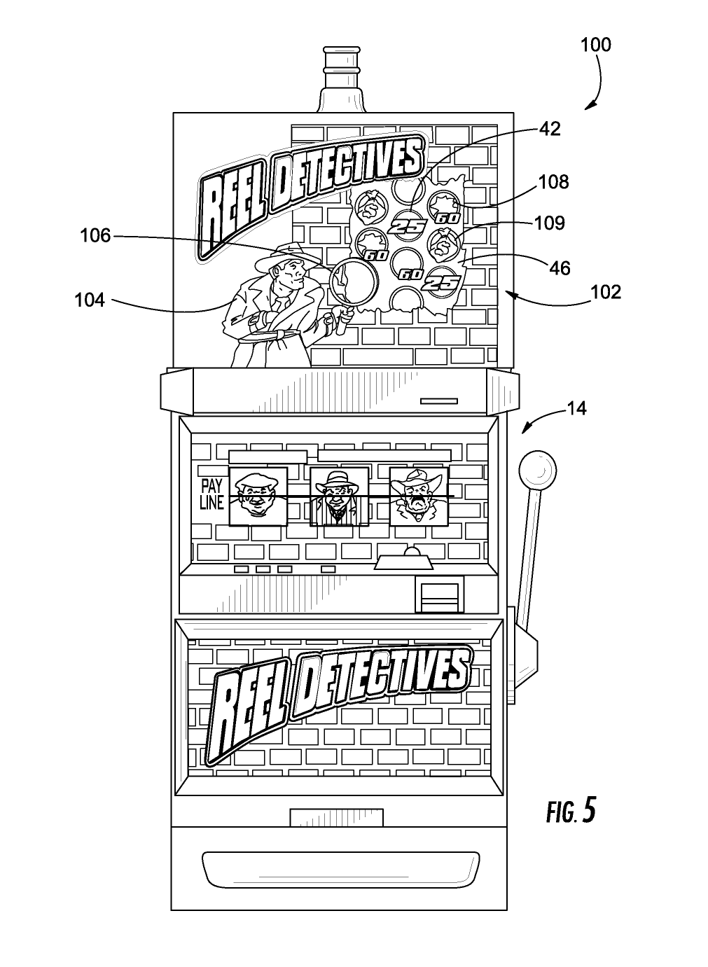

Referring now to FIG. 4, another embodiment of a positioning mechanism 150 is shown. Positioning mechanism 150 may be a vertically positioned worm gear 152 that is caused to rotate by an actuator 154. Indicator 43 may be attached to worm gear 152 by a bracket 156 that is attached to a nut 158 threaded on worm gear 152. A slot 160 may be provided in the front wall of second display 12 (FIG. 1a), which allows bracket 156 to pass through the wall. Sensors 162 may be provided to allow controller 140, or other control mechanisms (not shown), to detect the position of indicator 43. While indicator 43 is shown to move vertically in FIG. 4, it may be moved in any desired manner, including horizontally, diagonally, or in a non-linear fashion, such as in a rotating or zigzag manner.

In another embodiment, a wheel (not shown) may be attached to actuator 154. The periphery of the wheel may have at least one notch detectable by a sensor (not shown) and used by a bonus game controller 141 or a game controller 140 to monitor the position of indicator 43. Wheel and worm gear 152 may be rotated together by actuator 154. The sensor monitors the position of indicator 43 by detecting the notch. Bonus game controller 141 or game controller 140 may store information pertaining to the number of times the sensor has detected the notch and the corresponding position of movable indicator 43. An optical interrupt (not shown) may be provided to reset the indicator position information. The sensor may be an infrared source and detector. In alternative embodiments, the periphery of the wheel may comprise portions with different reflective characteristics, such as absorbent paint lines, instead of a notch on the wheel. Actuators 80 (FIG. 3) and 154 may be a stepper motor, a servo motor, a gear motor, a solenoid, a rack and pinion, or other actuators known in the art.

With continued reference to FIG. 4, an electronic controller 140 that utilizes a random number generator 142 may control gaming device 14 (FIG. 1a). Random number generator 142 produces a random or pseudo random number for each game. The outcome of the game may be determined by comparing the random number produced by random number generator 142 to a table of outcomes stored in a memory and accessed by controller 140. A number of different tables of outcomes may be used and different tables may be used for different games. The tables can be designed so that different prizes have different probabilities of being awarded. Such design techniques are well known in gaming and are described above. Examples of such designs are shown in U.S. Pat. No. 4,448,419, issued to Telnaes, and U.S. Pat. No. 5,456,465, issued to Durham, which are hereby incorporated by reference. Controller 140 may cause gaming outcome display 28 (FIG. 1a), e.g., game reels 30, 32, and 34, to display an outcome that corresponds to the random number generated by random number generator 142. Of course, gaming device 14 may operate in many other ways and still achieve the objects of the present invention.

Gaming device 14 may also be capable, via controller 140 or other control mechanism (not shown), of producing a bonus-activating event. This event may be many different types of events. For example, a bonus-activating event may comprise a game outcome such as displaying a particular symbol, e.g., a “bonus” symbol, or combination of symbols, such as a “7” symbol on each of reels 30, 32, and 34 (FIG. 1a). If the game being played is poker based, the bonus-activating event may be an occurrence of a certain hand, such as a royal flush. Furthermore, a bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, a bonus-activating event may occur when a group of players obtain a certain result. Sensors (not shown) may be provided external to gaming device 14 to detect external bonus-activating events.

Bonus game controller 141 may further be provided to detect when a bonus activating event occurs in gaming device 14. Gaming device controller 140 may determine the outcome of each game, and when a bonus-activating outcome occurs, gaming device controller 140 may transmit a signal to bonus game controller 141. Alternatively, bonus game controller 141 may periodically interrogate gaming device controller 140. Bonus game controller 141 and gaming device controller 140 may be a single controller or separate controllers. In at least one embodiment, gaming device controller 141 is the GAM 2000 controller, available from Eagle Engineering of Pottstown, Pa.

The bonus prize may be determined by a random number generator (not shown) and a virtual pay table, such as the pay table described in U.S. Pat. No. 5,823,874 to Adams, which is hereby incorporated by reference. A simple pay table may also appear as follows:

TABLE 1

| Random Number | Amount Paid |
|---|---|
| 0.00 to 0.50 | $10.00 |
| 0.51 to 0.75 | $50.00 |
| 0.76 to 0.95 | X2 |
| 0.96 to 1.00 | $10,000.00 |

For example, if the random number generator produced 0.45 as the game outcome, the controller may cause indicator 43 (FIG. 1a) to stop and pointer portion 64 (FIG. 1a) to point to an indicium representing ten dollars. Alternatively, if the random number generator produced a value of 0.85, the controller may cause indicator 43 to stop and pointer portion 64 to point to an indicium 44 representing a multiplier of 2. The controller may then cause bonus meter 68 (FIG. 1a) to display “10×2=20,” (assuming a base prize of ten dollars) and $20.00 would be awarded to the player.

The bonus selection process may be repeated for a predetermined number of times to accumulate several bonus prizes that are added to form the award to the game player. For example, the bonus game could be repeated three times to accumulate an award. The present invention is not limited to the example pay table shown. Furthermore, different kinds of bonus prizes may be awarded, such as progressive prizes, jackpot prizes, merchandise, services, prize multipliers, and additional games. Other effects may also be presented, such as pre-recorded sound from speakers 69 and 70 (FIG. 1a).

Speakers 69 and 70 may be configured to announce a prize a player has won, play music during a prize winning event, announce features of the game offered by gaming apparatus 10, or play music to attract and entertain patrons. Additionally, a variety of graphics and lights, preferably designed according to a particular theme, are displayed on second display 12 (FIG. 1a). If the awarded bonus prize is money, the amount of the bonus prize may be added to the player's credit meter (not shown), may be dispensed to the player via a voucher or other cashless device, may be dispensed to coin receptacle 20 (FIG. 1a), or an attendant may be summoned to award the prize to the player.

Referring now to FIG. 5, another embodiment of the invention, a gaming apparatus 100 similar to gaming apparatus 10 (FIG. 1a), is shown. Prize display 102 of gaming apparatus 100 may comprise display device 42. In this embodiment, band 46 is configured to move vertically around a horizontal axis of rotation. Prize display 102 also may comprise an indicator 104 that is similar to indicator 43 (FIG. 1a). Indicator 104 may have an appearance that conforms to a theme of the game, which is a detective game in this embodiment. Thus, indicator 104 may look like a detective, such as a man wearing a trench coat and a hat. In the embodiment illustrated in FIG. 5, indicator 104 moves horizontally. Indicator 104 may have a pointer portion 106. As shown in FIG. 5, pointer portion 106 is in the form of the detective's magnifying glass. The magnifying glass may be real or fake. If it is desired to have a functioning magnifying glass, the magnifying glass may comprise a standard magnifying lens, a fresnel lens, or other device known in the art. Pointer portion 106 may be configured to substantially cover an indicium selected by the controller (not shown) and magnify the indicium for the player to see. The mechanism for driving indicator 43, described above and shown in FIGS. 3 and 4, may be used for driving indicator 104.

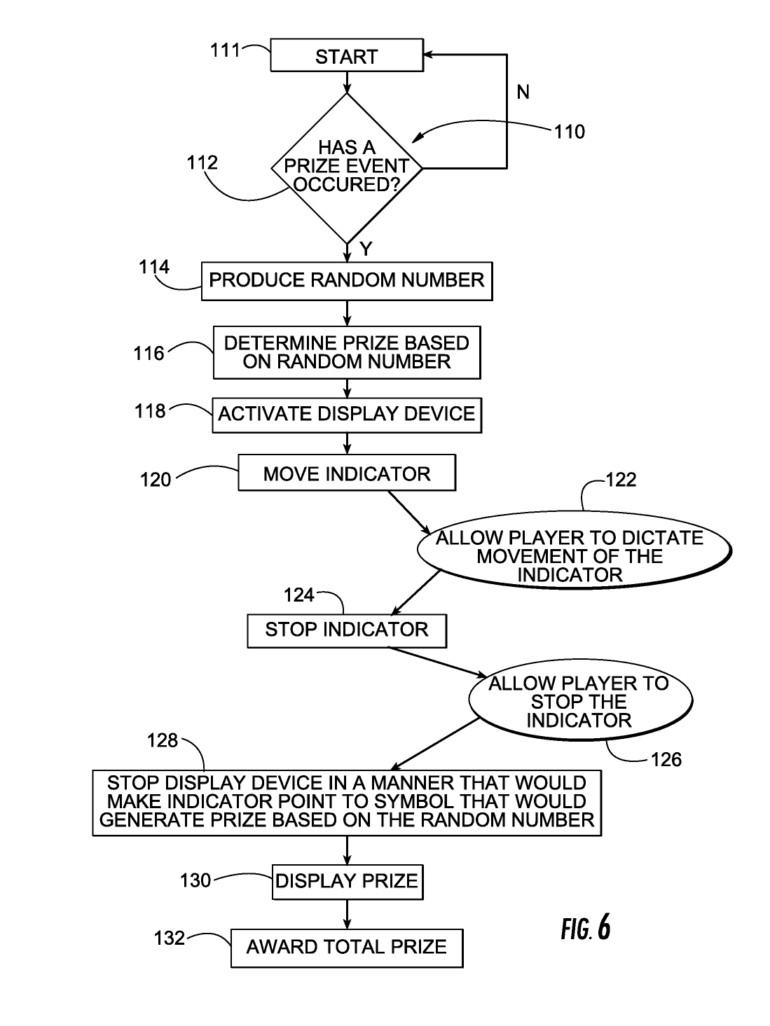

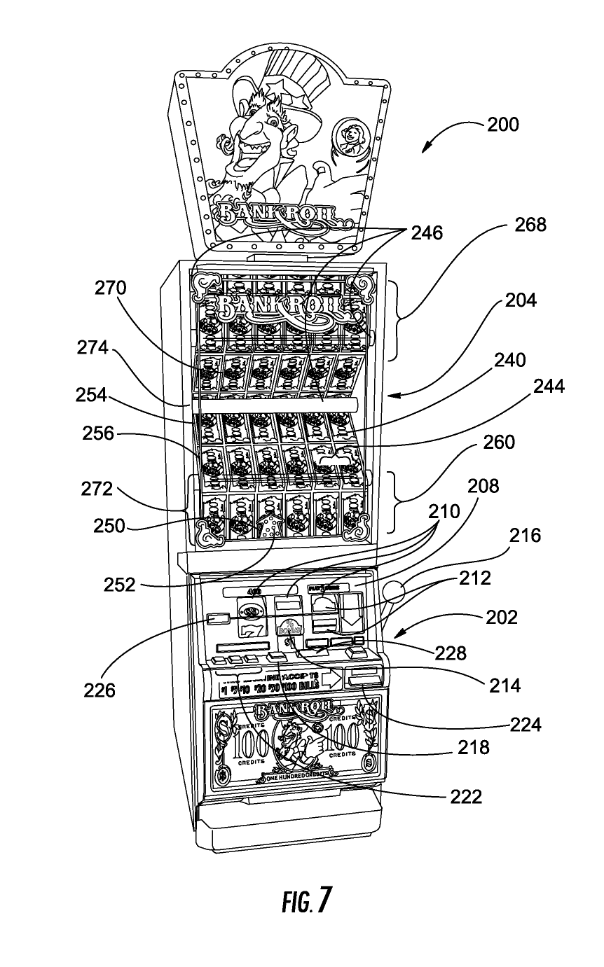

Referring now to FIG. 6, a gaming method 110 is shown wherein a player starts to play a game at step 111. A controller, such as controller 51, 81, 140 or 141, determines whether a prize event has occurred in step 112. If a prize event has occurred, the controller produces a random number at step 114. At step 116, the random number may be used to select a prize. At step 118, the controller may activate display device 42. At step 120, the controller may cause indicator 43 or 104 to move. Optionally, at step 122, the controller may allow a player to control the movement of indicator 43 or 104 by prompting the player to press one or more buttons (such as a button to move indicator 104 right and a button to move indicator 104 left) or another input device, such as a touch-pad, a joystick, or a mouse. At step 124, the controller causes indicator 43 or 104 to stop. Optionally, at step 126, the controller stops indicator 43 or 104 upon the activation of an input device by the player. At step 128, the controller causes display device 42 to stop in a manner that would make indicator 43 or 104 point to the corresponding symbol that would indicate the prize selected based on the random number previously generated by the controller. At step 130, the prize may be displayed on the bonus meter. Steps 118 to 128 may be repeated a predetermined number of times, and the sum of the prize values may be displayed. Lights and sounds may be generated to create a festive atmosphere. At step 132, a total prize may be awarded to the player. The cumulative prize may be multiplied by a multiplier in order to obtain the total prize. The multiplier may be fixed or randomly determined.

It is noted that the flowchart in FIG. 6 shows only one possible embodiment. Some of the steps in the flowchart may be varied, changed in order, or eliminated and still fall within the scope of the present invention.

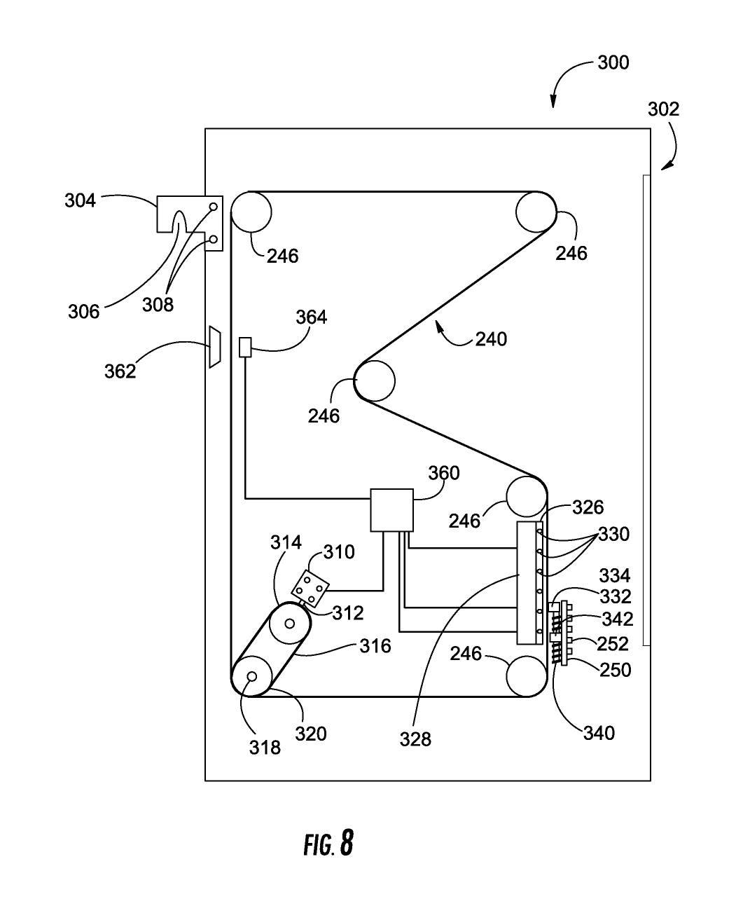

FIG. 7 shows an additional alternate embodiment of a gaming device according to the present invention. FIG. 7 shows a gaming apparatus 200 having a primary gaming device 202 and a gaming display 204, which may display all or part of a bonus game or primary game. Primary gaming device 202 may be configured similarly to previously discussed embodiments, and may include a plurality of mechanical or video reels 210 located on primary game display 208. A plurality of indicia 212 may appear on reels 210. A pay line 226 may be included to assist players in determining whether they have won the game. Value acceptors, including a coin acceptor 228 and a bill acceptor 224, may be included. The player may activate the game via button 218 or arm 216.

Primary gaming device 202 may operate in conjunction with gaming display 204. The appearance of one or more indicia 212 on pay line 226 may entitle the player to play gaming display 204. An example of bonus qualifying indicia is indicium 214.

Gaming display 204 may contain a band of material 240 that rotates about a plurality of rollers 246. Band 240 may have a plurality of indicia 244 appearing thereon. Indicia 244 may indicate various prizes. Band 240 may have an edge 254.

Band 240 may resemble a printing press, including a magazine printing press, a newspaper printing press, and a money printing press. As shown in FIG. 7, a least a portion of rollers 246 are arranged such that band 240 is displayed at a first position 268 of gaming display 204 located towards the front of gaming display 204. Band 240 then may be directed to a second position 270 of gaming display 204, such as passing behind roller 274, where band 240 is located more in an interior portion of gaming display 204. Band 240 may then be directed to a third position 272, which may be in the same plane as first position 268, located towards the front of gaming display 204. In this way, band 240 may appear to be passing through a printing press.

As illustrated in FIG. 7, band 240 appears to be a sheet of uncut paper currency, such as might be produced by the U.S. Treasury Department. Indicia 244 may appear to be currency bills having various values. Indicia 244 may indicate prizes such as an award of currency or credits, merchandise, services, game play, jackpots, and progressive prizes. Band 240 may have a variety of different indicia 244 imprinted, or otherwise appearing thereon.

Band 240 may be constructed from any suitable material. Band 240 may be constructed from a flexible material, such as various types of vinyl, plastic, rubber materials, and the like. The use of a flexible material may prevent band 240 from tearing or creasing when it is moved. The material used to construct band 240 may be transparent or translucent, allowing band 240 to be backlit.

Band 240 may be coupled to a drive mechanism (not shown in FIG. 7) so that band 240 may be rotated about rollers 246. In operation, band 240 may be actuated prior to a bonus prize being awarded to the player. Indicia 244 that may be awarded may appear in a particular area, such as area 260, for display to the player. Display area 260 may be lighted or otherwise brought to the player's attention.

In at least one embodiment, an indicator 250 is included that may point to particular indicia 244. Indicator 250 may be configured to point to an indicium 244 that conveys the outcome of gaming display 204. As shown in FIG. 7, indicator 250 is movable in a horizontal manner. However, gaming display 204 is not limited to any particular configuration, and indicator 250 may move vertically, diagonally, or in a non-linear manner, as desired by the game designer. Indicator 250 may be lit, such as by lights 252, in order to make indicator 250 more attractive and to call attention to indicator 250. In at least one embodiment, indicator 250 is illuminated only when gaming display 204 is active or when gaming display 204 is in an attract mode (such as has been previously described).

At least one advantage of band 240, as illustrated in FIG. 7, is that it may provide a relatively long path length. Accordingly, it may allow for more and/or larger indicia 244 to be included on band 240. A transparent bezel 256 may be mounted to cover the edge 254 of band 240.

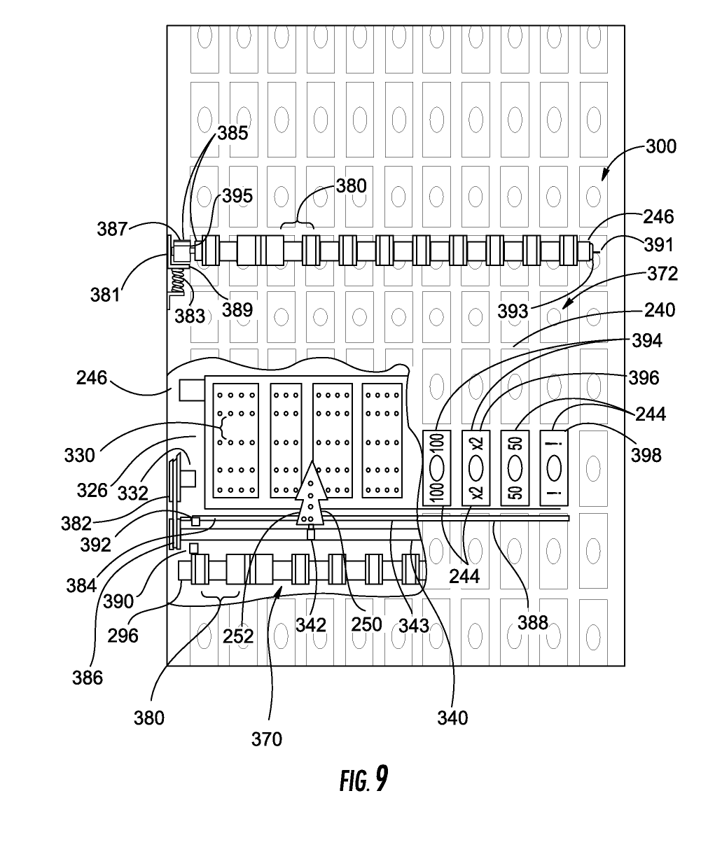

FIG. 8 illustrates certain components of a band display 300 that may be included in a gaming device according to the present invention, including that depicted in FIG. 7. Band display 300 may include a display device 302. FIG. 8 illustrates band 240 wrapped around a plurality of rollers 246. In at least one embodiment, all rollers 246 are idler rollers that simply guide band 240 about the interior of gaming display 204. One suitable roller is model number E8S001-01-ZZZZ available from Starpoint Electronics, Ltd. of Chessington, UK. A driven roller may be included to drive band 240. Driven roller 320 may be in communication with an actuator 310 in order to drive rotation of driven roller 320. One suitable driven roller is model E8S002-01-ZZZZ from Starpoint.

In at least one embodiment, band 240 is driven simply by frictional contact with roller 320. However, other arrangements may be substituted without departing from the scope of the present invention. For example, roller 320 may have a portion with teeth (not shown) that could engage slots or holes (not shown) in band 240.

Actuator 310 may be any number of suitable actuators, such as motors, including stepper motors, gear motors, and servo motors. Actuator 310 may rotate a shaft 312 in connection with a wheel 314. A belt 316 may link wheel 314 to shaft 318 of driven roller 320. Rotation of shaft 312 drives wheel 314 which in turn drives belt 316. The rotational force is passed from belt 316 to shaft 318. Rotation of shaft 318 may drive rotation of driven roller 320. Frictional contact with rotating driven roller 320 moves band 240. Optionally, an idler wheel or pulley (not shown) can be included on the opposing side of band 240 in order to increase the frictional contact of band 240 with driven roller 320.

In another embodiment, actuator 310 may be a stepper motor rotating a drive gear (not shown). The drive gear may be in communication with a spur gear (not shown) driving an idler shaft (not shown). The idler shaft in turn may be in communication with driven roller 320. The idler shaft may also used to help transfer power to the side of band 240 not located by actuator 310.

In at least one embodiment, band 240 may pass over an area proximate indicator 250. As shown in FIG. 8, indicator 250 may be attached to a worm gear 340. Worm gear 340 may be in communication with a suitable actuator 332, such as a servo motor, stepper motor, or the like. Indicator 250 may be attached to a bracket 342. Bracket 342 may be threadably attached to worm gear 340.

In at least one embodiment, indicator 250 includes one more lights 252 in order to call attention to indicator 250 and make indicator 250 more attractive. Lights 252 may be of any suitable type, including light emitting diodes (LEDs). Both lights 252 and indicator actuator 332 may be in communication with a controller, such as controller 360.

Controller 360 may direct lights 252 to illuminate and deactivate in accordance with game events, such as the execution of an attract mode, or a game outcome qualifying a player to play gaming display 204. Controller 360 also may direct the movement of indicator 250. For example, controller 360 may move indicator 250 upon activation of gaming display 204. Controller 360 may direct indicator 250 to stop, such as when a player activates buttons 222.

Controller 360 also may determine the position of indicator 250, for example if the controller is preset with the starting position of indicator 250, controller 360 may track the position of indicator 250 by knowing in which direction (or directions) indicator 250 was moved, how fast it was moved, and for what period of time. Depending on the actuator 332 used, actuator 332 may provide feedback as to the position of indicator 250 (for example, if an indexing stepper motor is used).

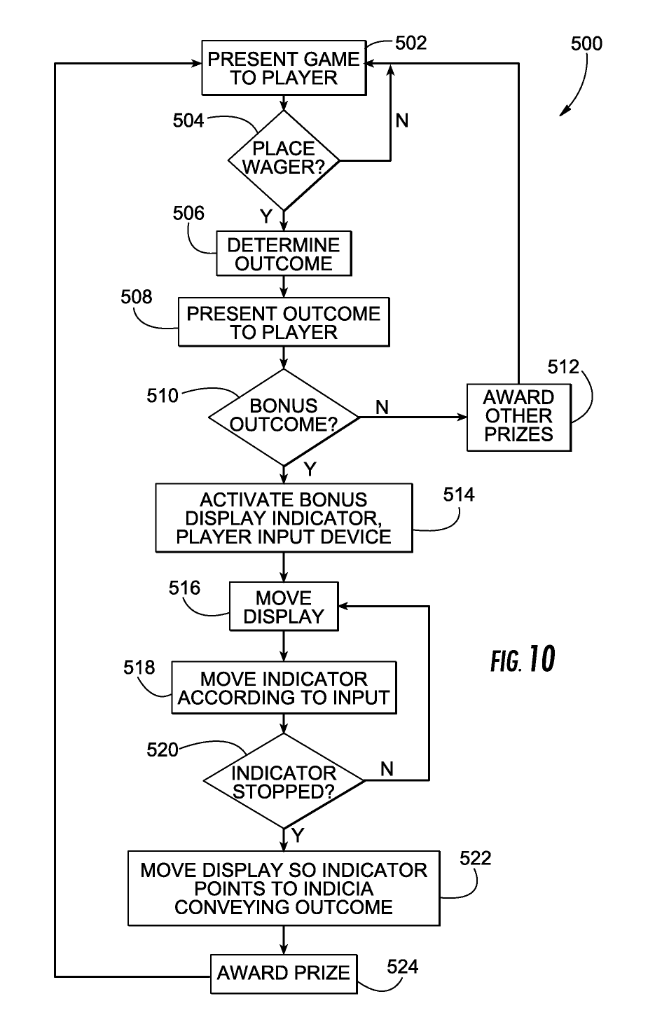

It may be beneficial to provide an additional position sensor for indicator 250. Those of skill in the art will recognize that various types of sensors could be used to track the position of indicator 250. In one embodiment, optical sensors are used. For example, an infrared signal generator may be included on one side of worm gear 340 (FIG. 9). An infrared detector may be placed on the other side of worm gear 340 (FIG. 9). When indicator 250 is not in between the generator and detector, the detector detects the infrared signal. When indicator 250 is interposed between the signal generator and detector, the detector does not detect a signal. Therefore, when the signal is interrupted, controller 360 knows the position of indicator 250. Such a positioning system may be a useful way to calibrate indicator 250.

Of course, other systems can be used, or additional signal generators and detectors used, including those that may allow for constant tracking of indicator 250. For example, an optical sensor (not shown) may be attached to bracket 342. Optical readable indicia and patterns may be placed along worm gear 340. As bracket 342 travels along worm gear 340 the sensor may read the indicia or patterns and communicate the position of indicator 250 to controller 360.

Controller 360 may also be in communication with a housing 328 that may have a plurality of lights 330. Lights 330 may be any suitable illumination device, including LEDs, fluorescent lamps, and incandescent lamps. Lights 330 may be activated by signals sent from controller 360 in response to game events. Lights 330 may be used to backlight band 240. Illumination of band 240 may result in a more appealing look for gaming display 204 and call more attention to the area of band 240 on which indicator 250 may indicate a prize.

Housing 328 may also contain a guide 326. Guide 326 may provide a surface to help position band 240. For example, guide 326 may help maintain band 240 in a taut position, and keep band 240 from wrinkling, creasing, tearing, or getting caught in any of the actuating mechanisms, including the actuating mechanism for indicator 250.

Controller 360 may also be in communication with a positioning system for band 240. It may be beneficial to be able to track the position of band 240. For example, when a game outcome is determined, it is important to make sure that indicator 250 points to the appropriate indicia on band 240.

Many suitable positioning systems can be used, including those used for indicator 250. For example, an infrared signal source 362 can be included on one side of band 240. An infrared detector 364 may be located on the opposing side of band 240. Infrared blocking materials may be placed at one or more locations on band 240. By tracking when the infrared signal is blocked, controller 360 may be able to calibrate and/or constantly track the position of band 240 and any indicia appearing thereon.

In an alternative embodiment, a side of band 240 contains a series of holes (not shown), cut-out portions, or similar optical interrupts. The optical interrupts may be read by an optical reader (not shown). The optical interrupts may convey the position of band 240 to controller 360.

Of course, gaming display 204 may be calibrated by the gaming operator from time to time, and position data from actuator 310, such as an indexing stepper motor, may also be used to track the position of band 240.

In at least one embodiment, the components of band display 300 shown in FIGS. 8 and 9 are modular in nature. That is, band 240, indicator, 250, and their actuating mechanisms may be added and removed from a gaming device as a unit. For example, as shown in FIG. 8, a hook 304 having a slot 306 may be attached to the frame of band display 300, such as by fasteners 308, such as bolts or rivets. A receiver (not shown), such as a bar, may be provided within the gaming device for attachment to hook 304.

FIG. 9 presents an alternate view of a gaming device according to the present invention. Portion 370 is a cut away view of the inner portion of an embodiment of gaming display 204. Portion 372 is an outer view of the embodiment.

In FIG. 9, it can be seen that in at least one embodiment, rollers 246 are fitted with a plurality of wheels 380. Wheels 380 may be made of a material that maintains strong frictional contact with band 240. Wheels 380 are preferably constructed of, or coated with, a relatively non-abrasive material so as not to damage band 240. For example, wheels 380 may be made of various types of rubber, plastic, and similar materials.

Rollers 246 may be provided with a tensioning system that may both help maintain the position of rollers 246, and maintain pressure on rollers 246 in order to ensure that band 240 is taut. The tensioning system may include a base 381, which may be mounted to the frame of gaming display 204 (FIG. 7). Base 381 may be coupled to a biasing device 383, such as a spring. Biasing device 383 may be coupled to a movable mounting area 385. Movable mounting area 385 may be moved along a track 387. Movable mounting area 385 may include a plate 389 that is mounted to biasing device 383.

Roller 246 may include a pin 391 and a shaft end 393. Pin 391 may be held within roller mounting area 395. Roller mounting area 395 may include a raised area defining a hole (not shown). When roller 246 is inserted, biasing device 383 will push roller 246 against band 240. Roller 246 may then rotate about pin 391 while keeping band 240 taut.

FIG. 9 also provides additional detail for a suitable actuator and positioning system for indicator 250. As was previously described, indicator 250 may be attached to worm gear 340 by bracket 342. Worm gear 340 may be actuated by actuator 332. Actuator 332 maybe attached to pulley 382 (which may be a timing pulley). Belt 384 (which may be a timing belt) may be attached to pulley 382 (which may be a timing pulley) and in contact with shaft end 386 of worm gear 340. A positioning system, such as infrared signal generator 390 and infrared detector 392, may be included in order to assist in tracking the position of indicator 250. In at least one embodiment, actuator 332 is stepper motor model HT23-396, available from Applied Motion Products of Watsonville, Calif.

In at least one embodiment, bracket 342 is configured to resist rotating as it travels along worm gear 340. One way this may be achieved is to include a rail 343 that runs parallel to worm gear 340. Bracket 342 may be coupled to rail 343. Rail 343 will prevent bracket 342 from rotating, while allowing linear movement along worm gear 340.

Turning now to portion 372 of FIG. 9, there is illustrated a number of indicia 244 appearing on band 240. As shown in FIG. 9, indicia 244 are representations of faux paper currency having various representations. Of course, any suitable indicia 244 may be placed on band 240. Indicia 244 may be chosen to be relevant to a theme of gaming apparatus 200, or gaming display 204, such as the “Bank Roll” theme shown in FIGS. 7 and 9.

Indicia 244 may represent prizes that a player may be awarded. For example, indicia 394 may represent an amount of money or gaming credits. Indicia 396 may represent a multiplier by which the player's winnings from one or more gaming rounds may be multiplied. Indicia 398 may represent special awards, such as a good, a service, a jackpot, or a progressive amount. Of course, indicia 244 may represent many other prizes without departing from the scope of the present invention.

In certain embodiments, portion 372 may include a slot 388. A portion of indicator 250 or bracket 342 may extend through slot 388. Slot 388 may allow indicator 250 to be displayed to the player, and actuated, but hides the inner workings of gaming display 204 (FIG. 7) from the player. Of course, other means of hiding the inner workings of gaming display 204, including the actuation system for indicator 250, from the player could be used. For example, rather than a slot, the actuation mechanism could be located below the area of gaming display 204 viewable by the player. Indicator 250 could be attached to the actuation mechanism in this area, and then extend upward into the area viewable by the player.

As illustrated in FIGS. 7 and 9, in certain embodiments pointer 250 moves along a first axis. Band 240 (which may function as a display surface) moves along a second axis. Indicia 244 appearing on band 240 move along the second axis as band 240 moves. In certain embodiments, the first axis is orthogonal to the second axis. The first and second axis may be used to define a coordinate system, with each indicia 244 appearing on band 240 corresponding to a specific coordinate in the system. Controller 360 may be programmed with the coordinates of each indicia 244, allowing controller 360 to ensure that the proper indicium or indicia 244 corresponding to a game outcome is displayed once band 240 and indicator 250 are stopped.

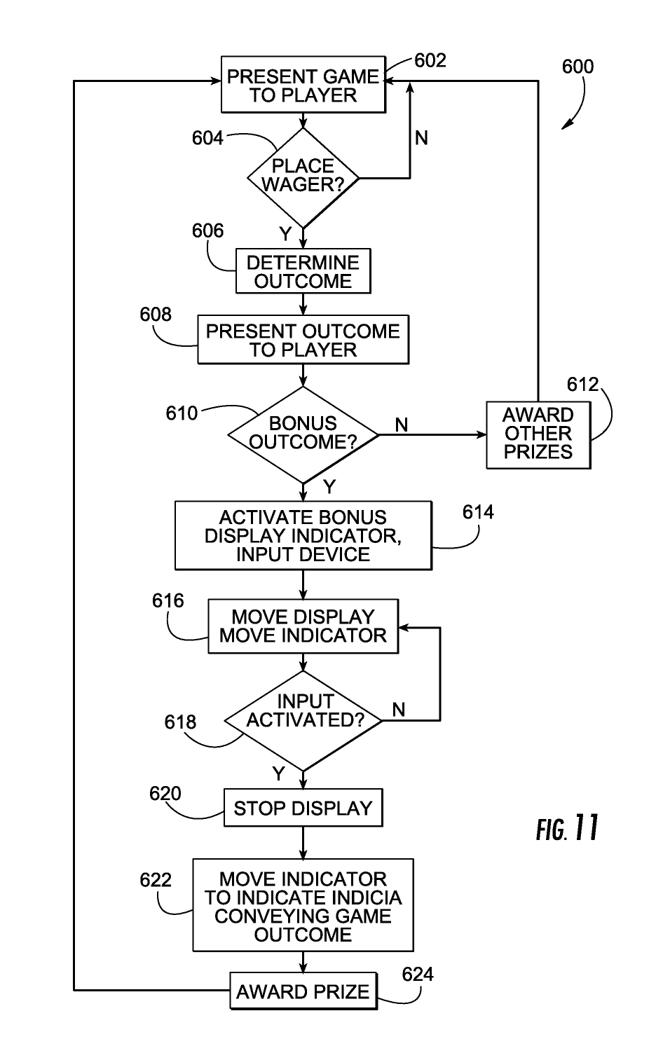

One method of operation 500 of an embodiment of the present invention, such as the device depicted in FIG. 7, is illustrated in FIG. 10. A game is presented to a player in step 502. At decision 504, method 500 checks to see if the player has placed a wager. If not, method 500 returns to step 502.

If the player places a wager at decision 504, method 500 proceeds to determine a game outcome in step 506. The outcome is presented to the player at step 508. At decision 510, method 500 checks to see if the game outcome determined in step 506 is an outcome qualifying the player to play a bonus game. If not, method 500 proceeds to step 512 and awards the player any prizes awarded according the game outcome determined in step 506, and then returns to step 502.

If it is determined in step 510 that the game outcome of step 506 qualifies the player for a bonus game, method 500 proceeds to step 514. At step 514, gaming display 204 is activated. This may include activation of band 240, indicator 250, and player input device 222. Lights and sounds may also be activated to make the event more exciting to the player and those around the player, as well as to call attention to the device.

Method 500 then proceeds to step 516 where band 240 is actuated. The player may be allowed to control the movement of indicator 250 using input device 222. For example, in the device depicted in FIG. 7, the player may be allowed to move the indicator left and right, and to stop the indicator at a desired location.

Method 500 proceeds to decision 520, which checks to see whether indicator 250 has been stopped. If indicator 250 has not been stopped, method 500 returns to step 518 and continues to move band 240 and allow the player to move indicator 250.

If decision 520 determines that the player has stopped indicator 250, method 500 proceeds to step 522. At step 522, a controller (which may be controller 51, 81, 140, 141, or 360) continues to move band 240 until the indicium corresponding to the game outcome is indicated by indicator 250. Method 500 then awards any prizes to the player in step 524 and returns to step 502.

Of course many variations of this method can be made without departing from the scope of the present invention. For example, the game outcome determined in step 506 can include both the outcome of the primary game and the bonus game. Alternatively, the bonus game outcome can be determined in a separate step once the bonus game begins.

FIG. 10 illustrates a method where band 240 moves at the same time a player is positioning indicator 250. In another embodiment, band 240 may be stationary while the player positions indicator 250. Once the player has chosen a position for indicator 250, band 240 can be moved until the appropriate indicium is indicated by indicator 250.

The player could be allowed to select the position of indicator 250 in a variety of ways. For example, the player could be provided with directional buttons and a stop button. Alternatively, indicator 250 could be moved in an automated fashion by controller 360. The player could activate a stop button when indicator 250 is at the position the player desires.

As may be apparent from the above description, it may be desirable to arrange indicia 244 on band 240 such that enough of each type of indicia 244 are included in order that any indicia can be indicated by indicator 250 at any position to which indicator 250 is moved. For example, in the embodiment illustrated in FIG. 7, indicia 244 are illustrated as appearing in a matrix of rows and columns, with indicator 250 being positionable at a particular column. Accordingly, it may be beneficial to have at least one of indicia 244 representing each prize that may be awarded appear on at least one row of each column of band 240.

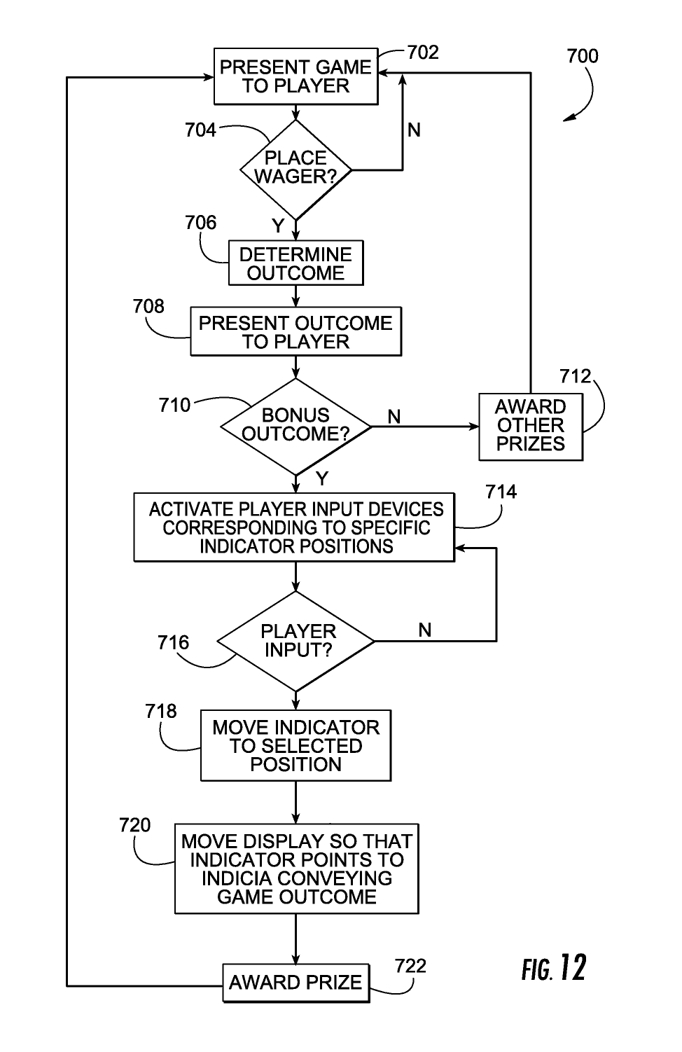

An alternative method of operation 600 is illustrated in FIG. 11. Steps 602-612 may correspond to steps 502-512 described above. At step 614, gaming display 204 may be activated, including band 240, indicator 250, and player input device 222. Lights and sounds may be activated, as previously described. Band 240 and indicator 250 are moved at step 616.

Decision 618 checks to see whether input device 222 has been activated. If input device 222 has not been activated, method 600 returns to step 616. If input device 222 has been activated, band 240 is stopped at step 620. Band 240 may be stopped quickly or may gradually come to a stop.

Method 600 then proceeds to step 622. At step 622, indicator 250 is moved to indicate the indicium conveying the outcome of the bonus game. Any prizes are awarded in step 624, and then method 600 returns to step 602.

Method 600 may be configured to allow a player to stop band 240 in a specific position, or simply to choose when band 240 will begin to stop. If the player is allowed to choose a specific position for band 240, it may be desirable to have at least one of each prize represented by indicia 244 that may be awarded appear on each row of band 240. Of course, if the player may not choose the exact position of band 240, it may be less desirable to include every indicia 244 on each row. Indeed, not allowing the player to choose an exact position for band 240 may allow a greater variety of indicia 244 to be presented on band 240.

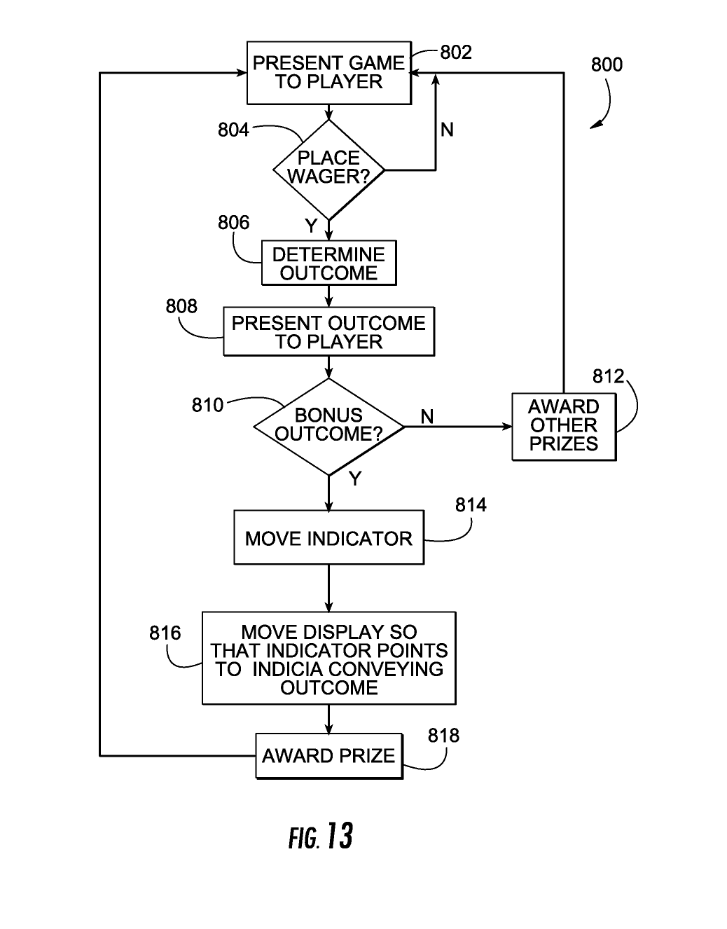

Another gaming method 700 is illustrated in FIG. 12. Steps 702-712 may correspond to steps 502-512 and 602-612 described above. At step 714, one or more player input devices are activated that allow a player to select one or more specific indicator positions. For example, indicia 244 on band 240 could be formed in a plurality of columns. The player input device(s) may allow a player to position indicator 250 by a specific column.

At step 716, method 700 checks to see if the player has provided input. If not, method 700 cycles back to step 714 until input is provided. Once the player has provided input, method 700 proceeds to step 718 and moves indicator 250 to the position selected by the player. At step 720, the display is moved so that indicator 250 points to the indicium conveying the game outcome. Any prize or prizes are awarded in step 722 and then method 700 may return to step 702.

In an alternative embodiment, the player may be allowed to choose a position after the game is begun. In any embodiment, the player's choice of position for indicator 250 might be reflected on band 240, such as illuminating a column of band 240 corresponding to the pre-set position of indicator 250 chosen by the player.

Various additions, subtractions, and permutations of the steps in the above described methods can be made without departing from the scope of the present invention. For example, the player may be allowed to select both the position of indicator 250 and to indicate when band 240 should begin to stop (although not the final position of band 240). The more the player is allowed to interact with gaming device 202, the more control over the outcome of the game the player may feel, which may make the game more enjoyable to the player. Of course, regulatory concerns may dictate that the player's perceived control be largely or completely illusionary.

Methods of operating gaming display 204, including methods 500, 600, and 700, may be set to automatically stop band 240 and/or indicator 250 after a certain time. For example, controller 360 could be programmed to automatically stop indicator 250 and/or band 240 after the passage of a certain amount of time, such as thirty seconds. While it may be beneficial to give the player some interaction with gaming display 204, it may also be desirable to ensure that each game round completes in a timely fashion.

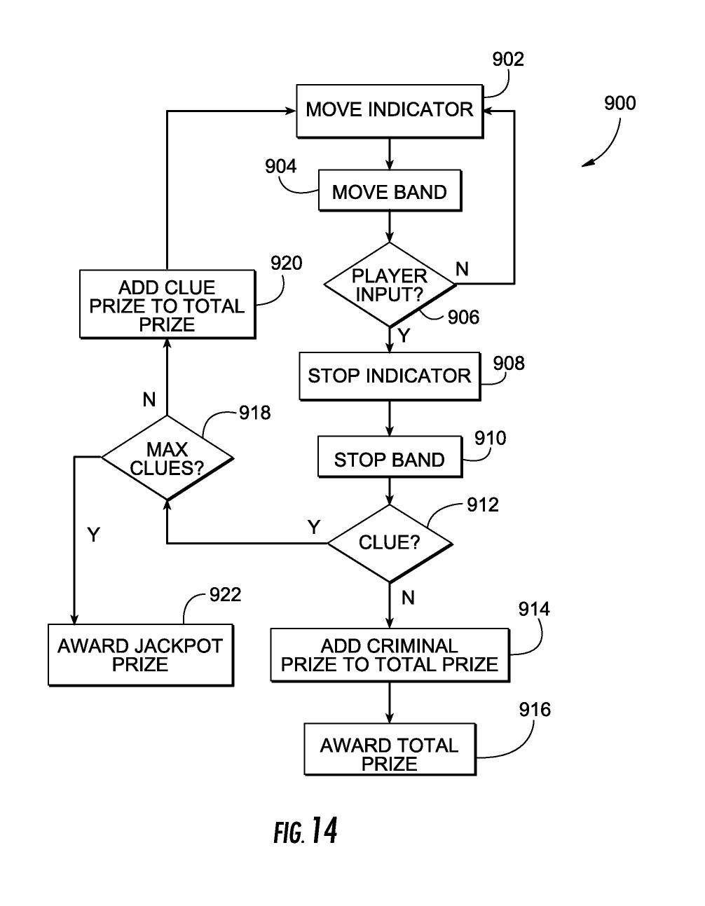

Of course, certain embodiments of the present invention, such as method 800 of FIG. 13, may employ no player input. Steps 802-812 may correspond to steps 502-512 of FIG. 10. At step 814, indicator 250 is moved to a position, which may be randomly selected by controller 360. At step 816 band 240 may be moved so that indicator 250 points to an indicium conveying the game outcome. Any prizes may be awarded at step 818 before method 800 returns to step 802. Of course, steps 814 and 816 may be reversed or presented simultaneously. Also, band 240 could be randomly moved, with indicator 250 being moved to indicate the game outcome.

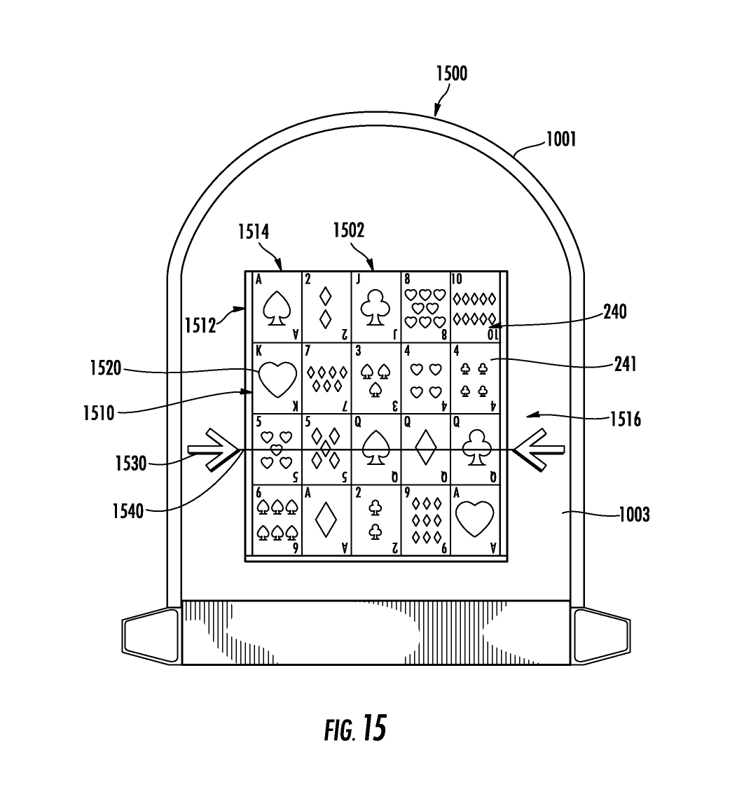

Another method 900 of game play that may be used with embodiments of the present invention, including that of FIG. 5, is shown in FIG. 14. Method 900 may award two types of prizes, illustrated in FIG. 5 as criminal prizes 108 or clue prizes 109. Of course, the prizes could be called or represent various things, have different values than those that will be described, and could be represented by images other than those specifically illustrated. After a game has begun, indicator 250 is moved at step 902. Band 46 is moved at step 904. A player input device is activated and the gaming device waits for player input at decision 906. If no player input is provided, method 900 cycles back to step 902. If input is provided, method 900 proceeds to step 908.

At step 908, indicator 250 is stopped. At step 910, band 42 is stopped so that indicator 250 indicates the indicium conveying the game outcome. Decision 912 checks to see if the indicium is a clue award or a criminal award. If the indicium is a criminal award, method 900 adds a criminal prize to the total prize at step 914. The total prize is awarded to the player at step 916.

If decision 912 determines that the indicium is a clue prize, method 900 proceeds to decision 918. Decision 918 checks to see whether the player has obtained a maximum number of clues, for example, 4. If not, method 900 proceeds to step 920 and adds a clue prize to the total prize, and game play continues at step 902.

If decision 918 determines that the player has obtained the maximum number of clues, method 900 awards a jackpot prize at step 922, and game play ends.

Although embodiments of the invention described and depicted in FIGS. 7-14 have been described as a bonus game in conjunction with a primary game, the present invention is not so limited. For example, gaming display 204 (FIG. 7) could be configured as a primary game. A player could make a wager. and gaming display 204 could indicate winning and losing outcomes and dispense prizes accordingly. Also, rather than being attached to a primary gaming device, gaming display 204 could be located apart from primary gaming device 202 (FIG. 7). Gaming display 204 could also be connected to multiple primary gaming devices 202. The present invention is not limited to a particular configuration or configurations.

Flexible Belt Card Game Embodiment

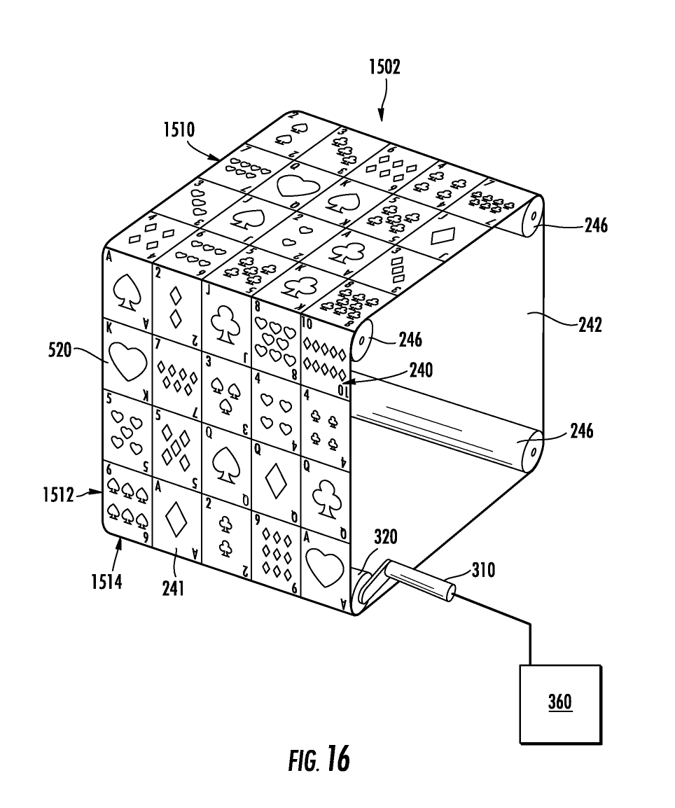

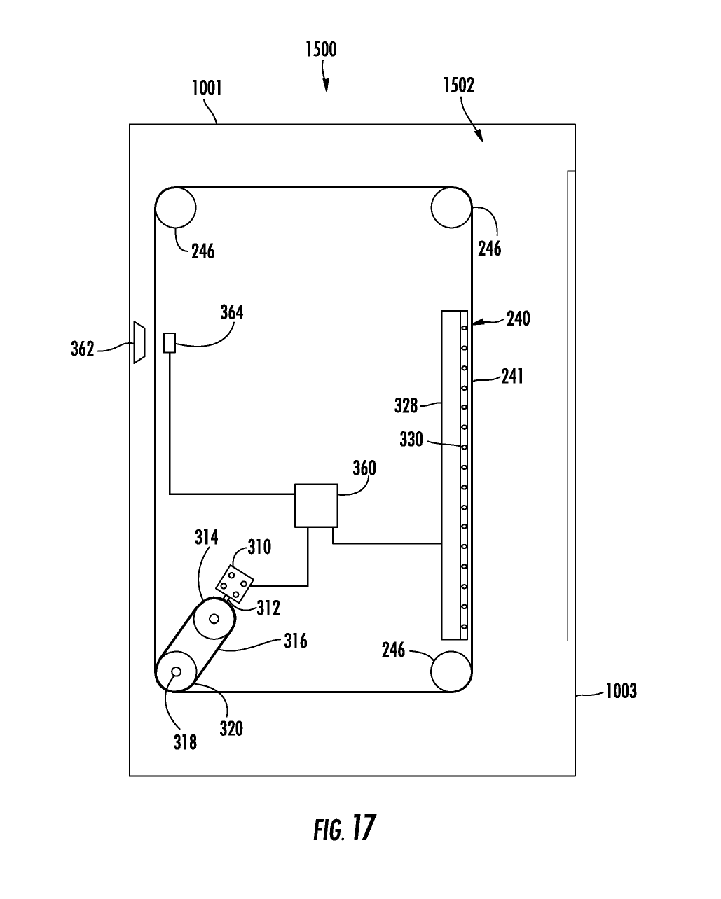

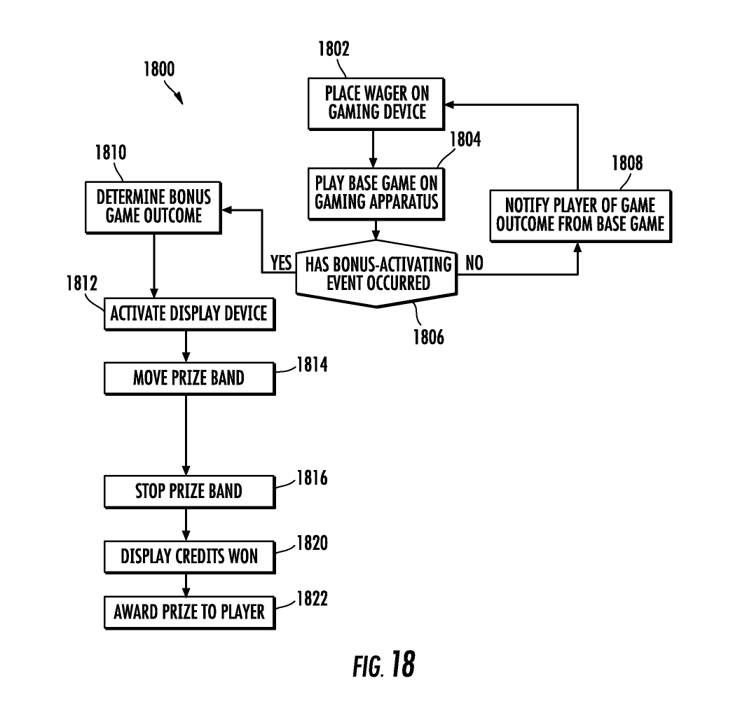

With reference now to FIGS. 15, 16 and 17, an additional embodiment of a gaming device according to the present invention is shown. Gaming device 1500 has a gaming display device 1502. Gaming device 1500 can be a bonus game that can be mounted in a housing 1001 in conjunction with a primary gaming device 202 as shown in FIG. 7.

Gaming display device 1502 can include a prize band 240 that is supported for rotational movement by rollers 246. Band 240 can have an outer display surface 241 and an inner surface 242. Band 240 can be a flexible belt. Band 240 can be backlit by lights 330 that are mounted in a housing 328 as was previously described. A pair of arrows 1530 can be mounted to front panel 1003 in order to draw attention to pay line 1540.

Band 240 can have a matrix 1510 of playing card indicia 1520 arranged on display surface 241. Playing card indicia 1520 can be arranged into four rows 1512 and five columns 1520. More or fewer rows 1512 could be used. Playing card indicia 1520 can contain any indicia that are contained in a standard deck of playing cards. That is any one of the 52 cards in a standard deck of cards can be displayed in matrix 1510. A large number of playing card indicia 1520 can be mounted on band 240. Alternatively, only a single row of playing card indicia could be mounted on band 240.

Pay line 1540 can indicate a card game outcome. For example, gaming display device 1502 could be a poker game display wherein five playing card indicia indicated by pay line 1540 can form a playing card hand 1516 as a game outcome. For example, in FIG. 15, pay line 1540 indicates the game outcome being a full house with a pair of “5” cards and three-of-a-kind of “queen” cards. A monetary award or credits can be associated with the playing card hand 1516 outcome using a standard pay table. For example, a full house may result in 50 credits being added to the game player's credit meter.

Controller 360 can rotatably control the position of band 240 using actuator 310 in the same manner as previously described for FIG. 7. The position of band 240 can be monitored by controller 360 using a sensor formed by source 362 and detector 364.

A game outcome can be indicated by pay line 1540. Pay line 1540 or arrows 1530 may be illuminated to draw further attention to the game outcome. As shown in FIG. 15, pay line 1540 is indicating a game outcome of a full house including three queens and a pair of five's.

Controller 360 can control and select the movement and position of band 240. Therefore, controller 360 can select the hand of playing card indicia 1520 that is dealt to the game player. As band 240 is rotated, the player can view the possible playing card hands and possible game outcomes.

Gaming display device 1502 can replace a video poker game display with a mechanical poker game display. Some players are reluctant to play video poker games because the display is dull and unattractive. Further, some players believe that video gaming devices do not pay as well as mechanical type devices. The present invention can provide a gaming apparatus to play a poker game that uses moving mechanical parts instead of a video display.

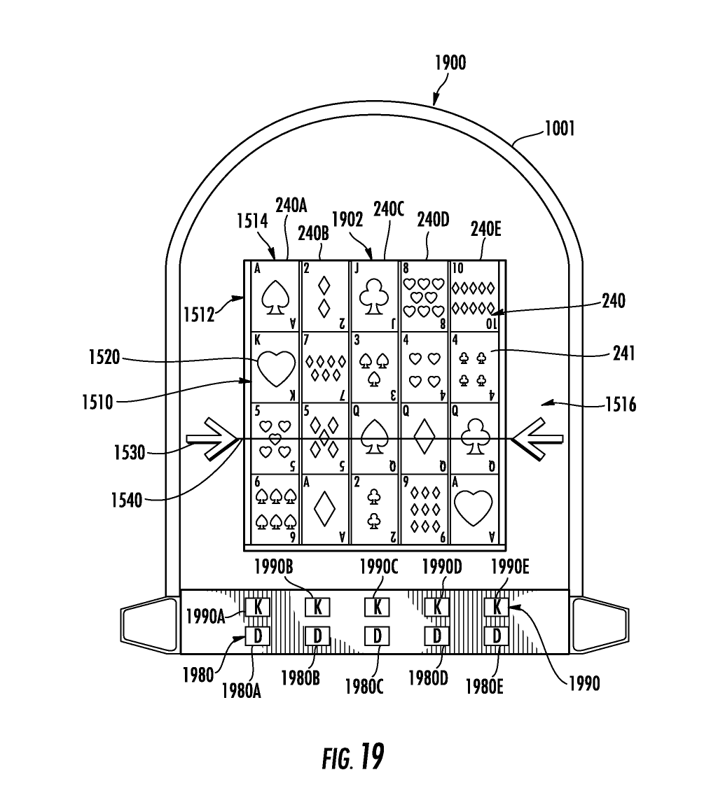

A method of operating gaming device 1500 of FIGS. 15-17 is shown in FIG. 18. In method 1800, a player places a wager on a primary gaming device at step 1802. At step 1804, the player plays a base game on the base gaming apparatus or primary gaming device 202 (FIG. 7). At decision 1806, method 1800 checks to see if the game outcome determined in step 1804 is an outcome qualifying the player to play a bonus game. If not, method 1800 proceeds to step 1808 and notifies the player of the game outcome determined in step 1804, and returns to step 1802.

If it is determined in step 1806 that the game outcome of step 1804 qualifies the player for a bonus game, method 1800 proceeds to step 1810. At step 1810, the bonus game outcome is determined. At step 1812, gaming display device 1502 is activated. This may include activation of band 240. Other lights and sounds may also be activated to make the event more exciting to the player and those around the player, as well as to call attention to the device.

Method 1800 then proceeds to step 1814, where band 240 is moved or rotated. At step 1816 band 240 is stopped. Method 1800 then displays the credits won or awarded associated with the playing card hands indicated by pay line 1540 and playing card indicia 1520 on the player's credit meter in step 1820. Any prizes are awarded to the player in step 1822.

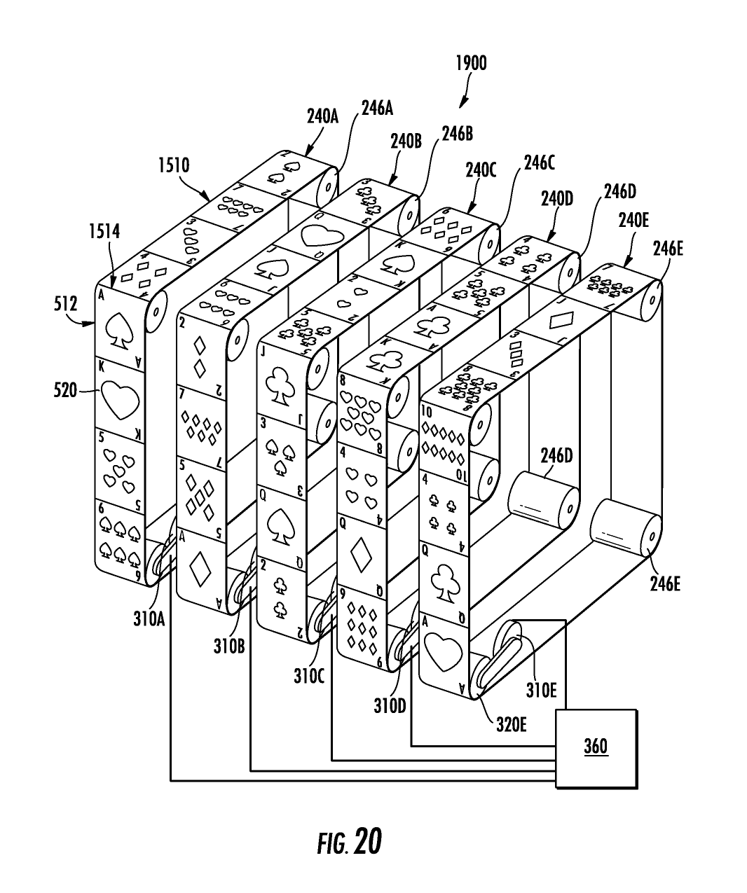

FIGS. 19-21 show another embodiment of a gaming device 1900. Gaming device 1900 has a gaming display device 1902. Gaming device 1900 is similar to gaming device 1500 except that band 240 comprises five bands 240A, 240B, 240C, 240D and 240E. Each band contains playing card indicia 1520 arranged in columns 1514. Bands 240A, 240B, 240C, 240D and 240E can be mounted adjacent to each other in housing 1001 such that they form matrix 1510.

Each individual band can be rotated or moved by an individual actuator. Band 240A can be rotated by actuator 310A. Band 240B can be rotated by actuator 310B. Band 240C can be rotated by actuator 310C. Band 240D can be rotated by actuator 310D. Band 240E can be rotated by actuator 310E. Actuators 310A-E rotate driven rollers 320A-E. Bands 240A-E are supported for rotation by rollers 246A-E. Actuators 310A, 310B, 310C, 310D and 310E can be in communication with controller 360. A tensioning mechanism (not shown) can be mounted adjacent to each of bands 240A-E The tensioning mechanism can move and adjust the tension on each band.

Controller 360 can control and select the movement and position of each of bands 240A, 240B, 240C, 240D and 240E. Therefore, controller 360 can select the hand of playing card indicia 1520 that is dealt to the game player. Controller 360 can select the row 1512 of playing cards that are displayed on pay line 1540. As band 240 is rotated, the game player can view the possible playing card hands and possible game outcomes.

Pay line 1540 can indicate a card game outcome. For example, game display 1502 could be a poker game display. The five playing card indicia 1520 indicated by pay line 1540 can form a playing card hand 1516 as a game outcome. For example, in FIG. 19, pay line 1540 indicates the game outcome being a full house with a pair of “5” cards and three-of-a-kind of “queen” cards. A monetary award or credits can be associated with the playing card hand outcome using a standard pay table. For example, a full house may result in 50 credits being added to the game player's credit meter.

The position of bands 240 can be monitored by controller 360 using a sensor formed by sources 362A-E and detectors 364A-E. A game outcome can be indicated by pay line 1540. Pay line 1540 or arrows 1530 may be illuminated to draw further attention to the game outcome.

Controller 360 can control and select the movement and position of band 240. Therefore, controller 360 can select the hand of playing card indicia 1520 that is dealt to the game player.

Several player input devices 1980 and 1990 can be mounted to housing 1001. Player input devices 1980 can comprise player input devices 1980A-E and player input devices 1990 can comprise player input devices 1990A-E. Player input devices 1980A-E and 1990 A-E can be buttons. Player input devices 1990A-E can be used by a game player to select which playing card indicia 1520 on pay line 1540 to keep. Player input devices 1980A-E can be used by a game player to select which playing card indicia 1520 on pay line 1540 to discard and be dealt again to obtain new playing card indicia 1520.

An initial hand would be shown to the player using bands 240A-E. The player would then be allowed to select which playing card indicia to keep and which to discard. After a player selects which playing card indicia to keep and which to discard, controller 360 then can move and stop the bands 240A-E corresponding to the selected player input devices 1980A-E that were depressed and keep the bands 240A-E stationary that were selected using player input devices 1990A-E in order to display a final playing card hand 1516.

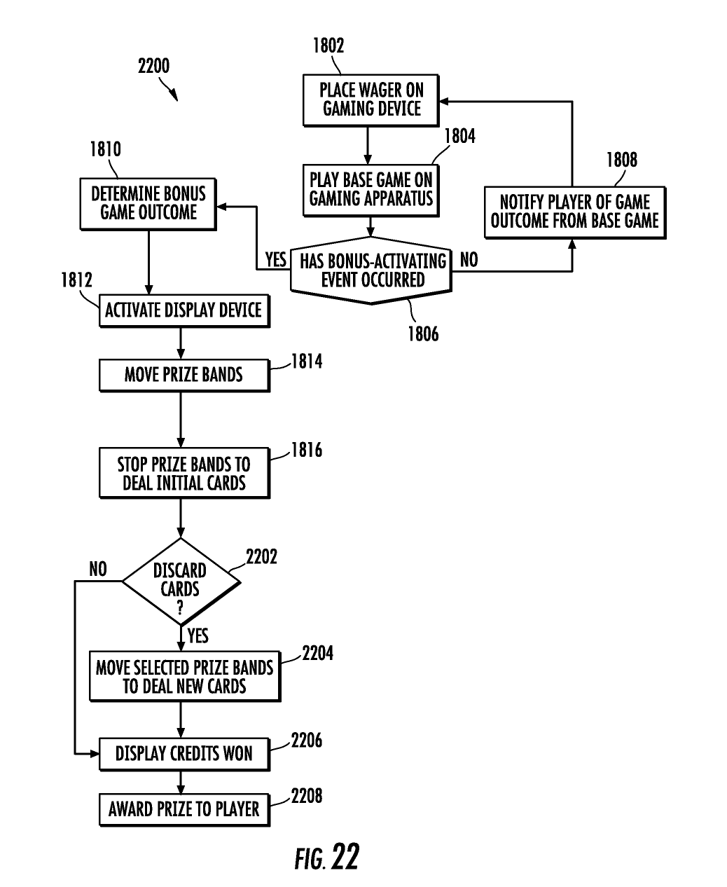

A method of operating gaming device 1900 of FIGS. 19-21 is shown in FIG. 22. In method 2200, a player places a wager on a primary gaming device at step 1802. At step 1804, the player plays a base game on the base gaming apparatus or primary gaming device 202 (FIG. 7). At decision 1806, method 2200 checks to see if the game outcome determined in step 1804 is an outcome qualifying the player to play a bonus game. If not, method 2200 proceeds to step 1808 and notifies the player of the game outcome determined in step 1804, and returns to step 1802.

If it is determined in decision 1806 that the game outcome of step 1804 qualifies the player for a bonus game, method 2200 proceeds to step 1810. At step 1810, the bonus game outcome is determined. At step 1812, gaming display device 1902 is activated. This may include activation of bands 240A-E and player input devices 1980A-E and 1990A-E. Other lights and sounds may also be activated to make the event more exciting to the player and those around the player, as well as to call attention to the device.

Method 2000 then proceeds to step 1814, where bands 240A-E are moved or rotated. At step 1816, bands 240A-E are stopped to display an initial hand of playing card indicia 1520 on pay line 1540. Next, the player is allowed to choose which playing card indicia 1520 to keep and discard at decision 2202, using player input devices 1980A-E and 1990A-E.

If the player chooses to discard cards at decision 2202, method 2200 then proceeds to step 2204 where the bands associated with the discarded cards are moved to display new playing card indicia 1520. Next, at step 2206, any credits won associated with the playing card hand 1516 indicated by pay line 1540 are displayed on the player's credit meter.

If the player chooses not to discard any cards in step 2202, step 2202 proceeds to step 2206, where any credits won associated with the playing card hand 1516 indicated by pay line 1540 are displayed on the player's credit meter. Any prizes are awarded to the player in step 2208.

### ALTERNATIVE EMBODIMENT

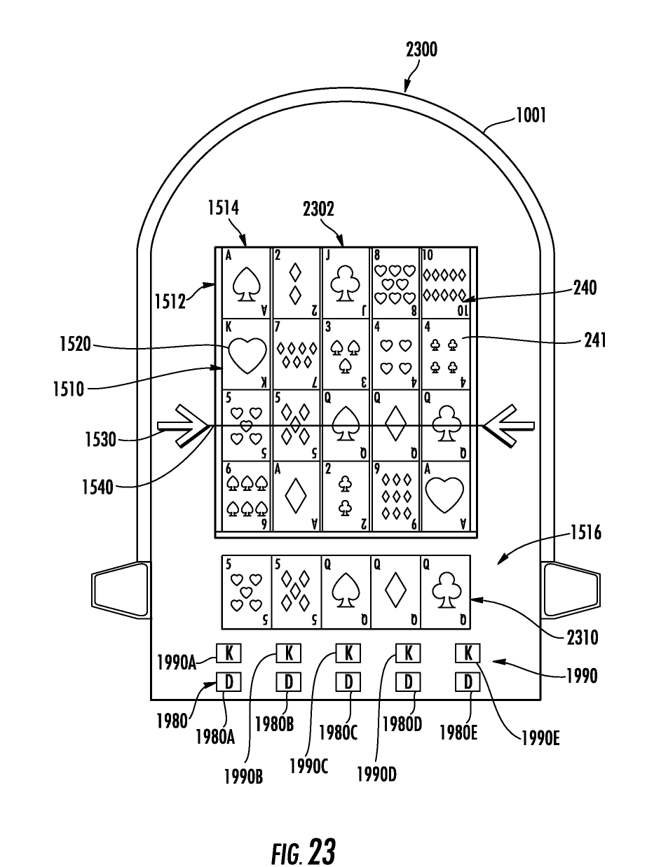

Turning now to FIG. 23 another embodiment of a gaming device 2300 is shown. Gaming device 2300 has a gaming display device 2302. Gaming device 2300 is similar to gaming device 1900 except that a video display 2310 has been added below bands 240 A-E. Video display 2310 can be used to track and display the playing card indicia 1520 that are initially dealt and can track and display any discarded playing card indicia. Video display 2310 can also display the game outcome playing card hand 1516.

In another embodiment, video display 2310 can be used to display the initially dealt playing card hand 1516 of playing card indicia 1520. Bands 240A-E can be used to display any new or replacement playing cards that are dealt or displayed by controller 360.

Flexible Belt Game Embodiment

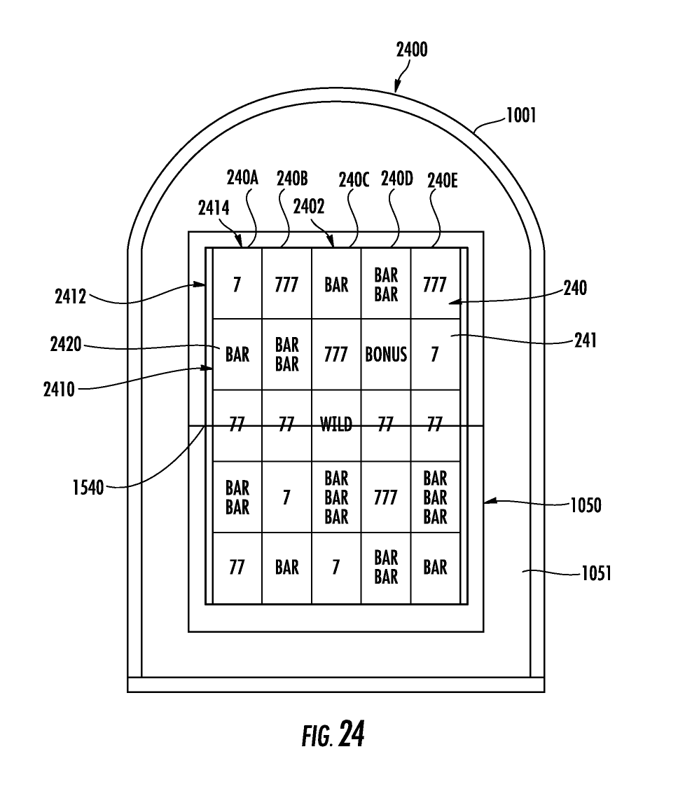

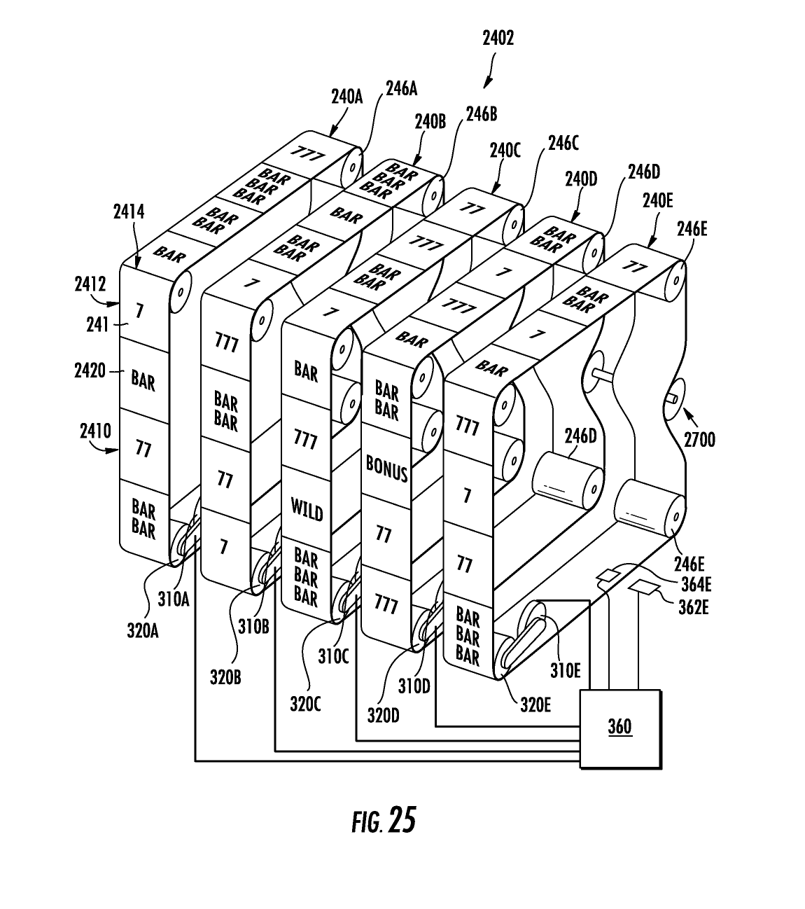

With reference now to FIGS. 24, 25 and 26, an additional embodiment of a gaming device according to the present invention is shown. Gaming device 2400 has a gaming display device 2402 that allows a player to play a flexible belt game. Gaming device 2400 can be a primary game that operates alone or game be a bonus game that can be mounted in a housing 1001 in conjunction with a primary gaming device 202 as shown in FIG. 7.

Gaming display device 2402 can include five prizes bands or flexible belts or prize bands 240A, 240B, 240C, 240D and 240E that are supported for rotational movement by rollers 246A-E. Each band contains game indicia 2420 arranged in columns 2414. The flexible belts each are continuous or endless and can be made from a suitable material such as rubber or plastics. Flexible belts 240A, 240B, 240C, 240D and 240E can be mounted adjacent to each other in housing 1001 such that columns 2414 and rows 2412 form a 5×5 matrix 2410. Each of the belts has an outer display surface 241 and an inner surface 242. Flexible belts 240A-E can be at least partially transparent and can be backlit by lights 330 that are mounted in a housing 328 as was previously described.

Flexible belts 240A-E can have a matrix 2410 of game indicia 2420 arranged on display surfaces 241. Game indicia 2420 can be arranged into five rows 2412 and five columns 2414. More or fewer rows and columns could be used. Game indicia 2420 can contain a wide variety of indicia that are attractive to a game player. For example, game indicia 2420 may include letters, words, numbers, symbols, pictures, images, objects or avatars.

Each individual belt or band can be rotated or moved by a positioning mechanism 309. Positioning mechanism 309 comprises actuators 310A-E, shafts 312, wheels 314, belts 316, link wheel 314, shaft 318 and driven roller 320.

Actuators 310A-E may be any number of suitable actuators, such as motors, including stepper motors, gear motors, and servo motors. Actuators 310A-E may rotate a shaft 312 in connection with a wheel 314. A belt 316 may link wheel 314 to shaft 318 of driven roller 320. Rotation of shaft 312 drives wheel 314 which in turn drives belt 316. The rotational force is passed from belt 316 to shaft 318. Rotation of shaft 318 may drive rotation of driven roller 320. Frictional contact with rotating driven roller 320 moves band 240.

Band 240A can be rotated by actuator 310A. Band 240B can be rotated by actuator 310B. Band 240C can be rotated by actuator 310C. Band 240D can be rotated by actuator 310D. Band 240E can be rotated by actuator 310E. Positioning mechanism 309 includes actuators 310A-E that turn a pulley 314 that drives belt 316 to rotate driven rollers 320A-E. Bands 240A-E are supported for rotation by rollers 246A-E. Actuators 310A, 310B, 310C, 310D and 310E can be in communication with controller 360. A tensioning assembly, device or mechanism 2700 can be mounted to housing 1001 and in contact with each of belts 240A-E. Tensioning assembly 2700 can move and adjust the tension on belts 240A-E.

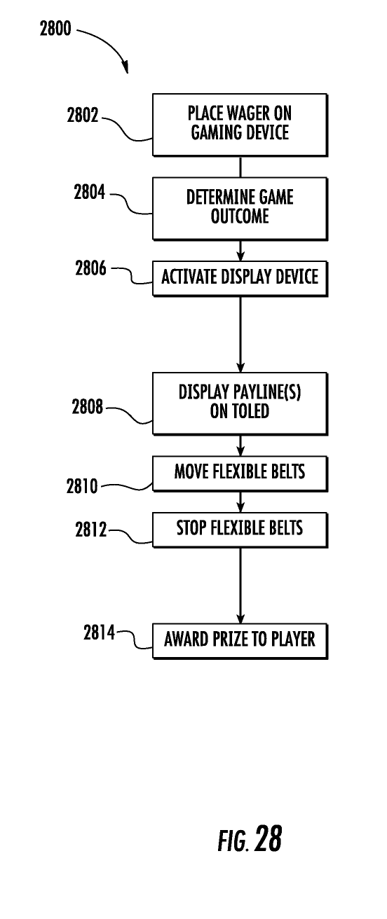

Turning to FIG. 27, details of tensioning assembly, device or mechanism 2700 are shown. Tensioning assembly 2700 maintains the position of rollers 246A-E and maintains the proper amount of pressure on rollers 246A-E in order to ensure that flexible belts 240A-E are taut and at the proper tension to be driven by driven rollers 320A-E. Tensioning assembly 2700 can include an elongated circular bar or rod 2702 having ends 2708 and 2709. A series of rotatable bearings 2704A-E are mounted to rod 2702. Tensioning rollers 2706A-E can be mounted to bearings 2704A-E such that each of tensioning rollers 2706A-E are free to rotate in an independent manner about bearings 2704A-E.

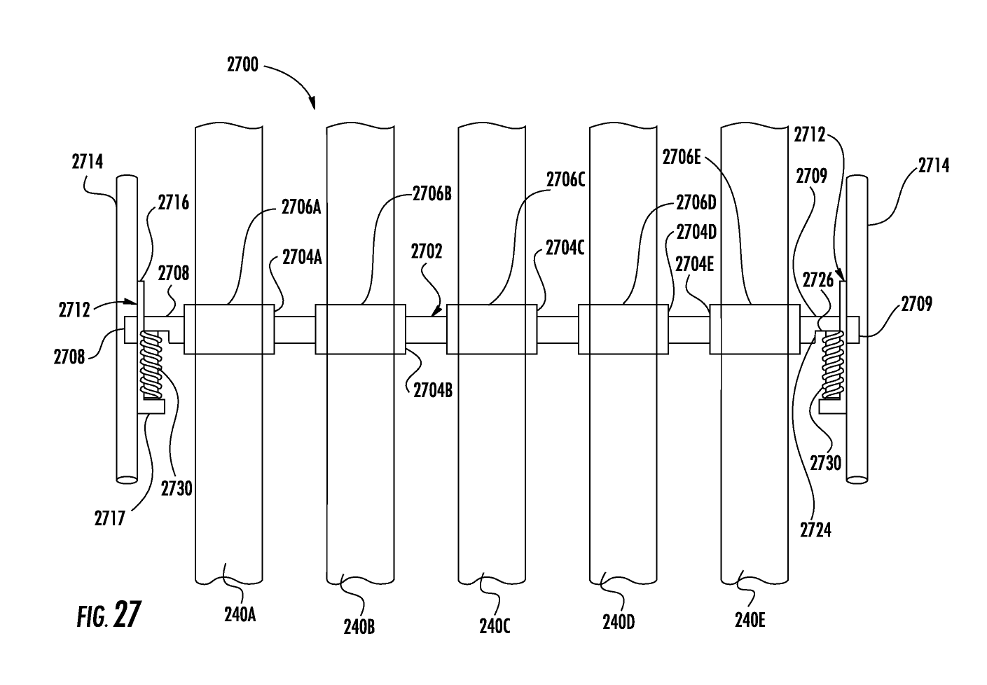

A pair of L-shaped rails 2712 are coupled to frame members 2714. One frame member 2714 is adjacent to band 240A and another is located adjacent to band 240E. Frame member 2714 can be coupled to housing 1001 (FIG. 26). Rails 2712 have a side portion 2716 and a base 2717. Rails 2712 can have a series of slots 2720 (FIG. 26) that extend along the length of a portion of rail 2712. Bar ends 2708 and 2709 extend through a pair of opposed slots 2720 such that rod 2702 can have a small amount of vertical travel but be fixed in a horizontal position. Each bar end 2708 and 2709 can have a recess 2724 that has a flat portion 2726.

A pair of biasing devices 2730, such as coil springs may be retained in compression between base 2717 and recess 2724. Biasing devices 2730 bias rod 2702 in an upward direction causing tensioning rollers 240A-E to be moved against flexible belts 240A-E resulting in an increase in the tension in flexible belts 240A-E. In an embodiment, rails 2712 may further include an adjustment mechanism (not shown) such as a pair of slotted plates in order to allow further adjustments in the tension of flexible belts 240A-E.

With continued reference to FIGS. 24, 25 and 26, controller 360 can control and select the movement and position of each of flexible belts 240A, 240B, 240C, 240D and 240E. The position of flexible belts 240A-E can be monitored by controller 360 using a sensor formed by sources 362A-E and detectors 364A-E.

Therefore, controller 360 can select the game indicia 2420 that is shown or displayed to the game player. Controller 360 can select the row 2412 of game indicia that are displayed on pay line 1540. As the flexible belts 240A-E are rotated, the game player can view the possible game outcomes.

Pay line 1540 can indicate a game outcome. The five game indicia 2420 indicated by pay line 1540 can indicate a game outcome. For example, in FIG. 24, pay line 1540 indicates the game outcome being four “77” symbols and a “wild” symbol. A monetary award or credits can be associated with the game indicia outcome using a standard pay table. For example, the game outcome shown in FIG. 24 may result in 100 credits being added to the game player's credit meter.

Gaming display device 2402 can replace a video game display with a mechanical game display. Some players are reluctant to play video games because the display is dull and unattractive. Further, some players believe that video gaming devices do not pay as well as mechanical type devices. The present invention can provide a gaming apparatus to play a game that uses moving mechanical parts instead of a video display.

Gaming display device 2402 can include a transparent touch sensitive display, or transparent touch screen such as a transparent touch sensitive organic light emitting display (TOLED) 1050. A TOLED device may also be referred to as transparent organic light emitting diode display. Transparent organic light emitting display 1050 can be mounted to front panel 1003 of housing 1001 and cover at least a portion of flexible belts 240A-D.

TOLED 1050 can be mounted to front panel 1003 by a variety of means. For example TOLED 1050 can be attached to front panel 1003 by fasteners. TOLED 1050 could also be placed in a housing or bezel that is then attached to front panel 1003. Transparent organic light emitting display 1050 can have a front surface 1051 and a back surface 1052. A game player playing gaming device 2400 would face and view front surface 1051. Because TOLED 1050 is transparent the display surfaces 241 of flexible belts 240A-E are readily viewable by the game player.

A transparent organic light emitting display is a flexible full-color flat-panel display with a level of brightness, viewing angle, and sharpness that is not possible with traditional flat-panel displays. Transparent organic light emitting displays are transparent except for the areas or sections of the display that are energized and actively showing images. Transparent organic light emitting displays are flexible, thin and lightweight making them well suited for a variety of applications. Transparent touch sensitive organic light emitting displays are commercially available.

Transparent organic light emitting displays have a unique distinct look that can attract attention to the gaming device. In addition, the transparent organic light emitting display can offer the gaming operator more choices of symbols to be displayed and possible game outcomes. A TOLED is constructed on a transparent substrate through which the light emitted by the device is viewed, and the device structure typically includes, in sequence, the transparent substrate, a transparent conductive hole-injecting electrode, an organic hole-transporting layer, an organic light-emitting layer, an organic electron-transporting layer and an electron-injecting electrode (cathode) consisting of a metal having a low work function. A TOLED converts electric energy into light energy. TOLED technology incorporates organic luminescent materials that, when sandwiched between electrodes and subjected to a DC electric current, produce intense light of a variety of colors. These TOLED structures can be combined into the picture elements or pixels that comprise a display.

A TOLED can be manufactured to be top-only emitting, bottom-only emitting, or both top and bottom emitting. A display using TOLED technology can greatly improve contrast, making it much easier to view displays in bright sunlight.

Electrical power and signal information can be supplied to the TOLED display 1050 by an electrical cable 1053. Controller 360 can be in communication with TOLED 1050 through cable 1053. Controller 360 can present or display a wide variety of images, symbols, video presentations or indicia on TOLED 1050.

Controller 360 can selectively provide signals to a matrix of X and Y coordinates in TOLED display 1050 to create the desired image. Controller 360 can selectively turn areas of TOLED 1050 from clear or transparent to opaque and likewise can turn areas that are opaque to transparent.

Software in conjunction with known display controller technology is used to store a pattern of bits in a memory corresponding to the image to be displayed. One possible display may be a raster scan that selectively energizes the TOLED display by rows and columns at a rapid rate.

TOLED display 1050 can be formed into a wide variety of shapes including convex sections, concave sections, curved sections and flat sections. In FIGS. 24 and 26, TOLED 1050 is shown as having a square flat shape. However, TOLED display 1050 could be bent into various angles and curves to form a wide variety of interesting and attractive shapes.

Flexible belts 240A-E may be backlit by several lights 330 that are mounted in a housing 328 that is positioned behind belts 240A-E. Lights 330 are in communication with and can be controlled by controller 360. Lights 330 can be turned on and off or flashed in a sequence when a game event has occurred. For example, the lights that are behind the indicia 2420 that correspond with a pay line 1540 award can be illuminated.

In an embodiment, TOLED 1050 may initially present no images and be transparent. Flexible belts 240A-E can rotate causing indicia 2420 on belts 240A-E to move in a vertical direction. Indicia 2420 can be moved from top to bottom or from the bottom to the top of rows 2414. Because TOLED 1050 is transparent, a game player viewing TOLED 1050 would see indicia 2420 moving up or down through TOLED 1050. A portion of belts 240A-E that are visible may not be located behind TOLED 1050. Alternatively, all of belts 240A-E that are visible may be located behind TOLED 1050.

With specific reference now to FIG. 24, TOLED 1050 is shown in an active state displaying video presentations or images as directed by controller 360. TOLED 1050 can display one or more pay lines 1540. Pay line 1540 can indicate a set of indicia 2420 as a game outcome. While one pay line 1540 is shown a wide variety of pay lines can be shown across matrix 2410 in various directions such as vertical, horizontal, diagonal or random. Pay lines 1540 can be shown in a wide variety of colors and styles that are attractive to casino patrons.

After a period of time, the rotation of flexible belts 240A-E can be stopped by controller 360. A game outcome can be indicated by the combination of indicia 2420 and payline 1540 shown or displayed on TOLED 1050. Any prizes won can be awarded and added to the player's credit meter. The indicia 2420 could further be indicated as a game outcome by illuminating backlights 330. If desired, more than one set of indicia 2420 could be indicated as the game outcome by the use of multiple pay lines 1540.

Gaming device 2400 conveys a game outcome indicated by the combination of the indicia 2420 on display surface 241 of flexible belts 240A-E and the display generated on transparent touch sensitive organic light emitting display 1050. In an embodiment, TOLED 1050 can generate a display that shows a variety of prize multipliers. The prize multiplier can be used to multiply the credits indicated by pay line 1540 to award a larger or alternative prize. For example, the prize multiplier 2× could be displayed and illuminated and then multiplied by the number of credits indicated by pay line 1540.

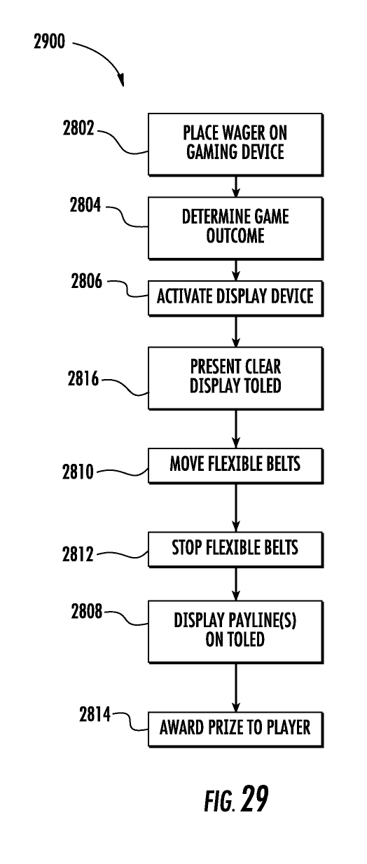

A method 2800 of operating gaming device 2400 of FIGS. 24-27 is shown in FIG. 28. In method 2800, a player places a wager on gaming device 2400 at step 2802. At step 2804, the game outcome is determined. The game outcome may be determined using a random number generator or may be determined by a random number generator programmed in controller 360 (FIG. 26). At step 2806, gaming display device 2402 (FIG. 24) is activated. This may include activation of flexible belts 240A-E (FIG. 24) and touch sensitive transparent organic light emitting display (TOLED) 1050 (FIG. 24). Other lights and sounds may also be activated to make the event more exciting to the player and those around the player, as well as to call attention to the device.

Method 2800 then proceeds to step 2808 where controller 360 directs transparent organic light emitting display 1050 to show one or more payline(s). At step 2810, controller 360 causes one or more of flexible belts 240A-E to move or rotate. The game player can then view flexible belts 240A-E and indicia 2420 moving through TOLED 1050. The moving flexible belts 240A-E can be stopped in step 2812. The game outcome is indicated by the combination of pay line 1540 shown on TOLED 1050 and indicia 2420 shown on flexible belts 240A-E. Any prizes or credits won can be awarded to the player in step 2814.

The order of the various steps shown in method 2800 may be altered and rearranged while still indicating a game outcome. For example, the pay line(s) could be displayed while the flexible belts are moving. In this case, step 2808 would be performed after step 2810.

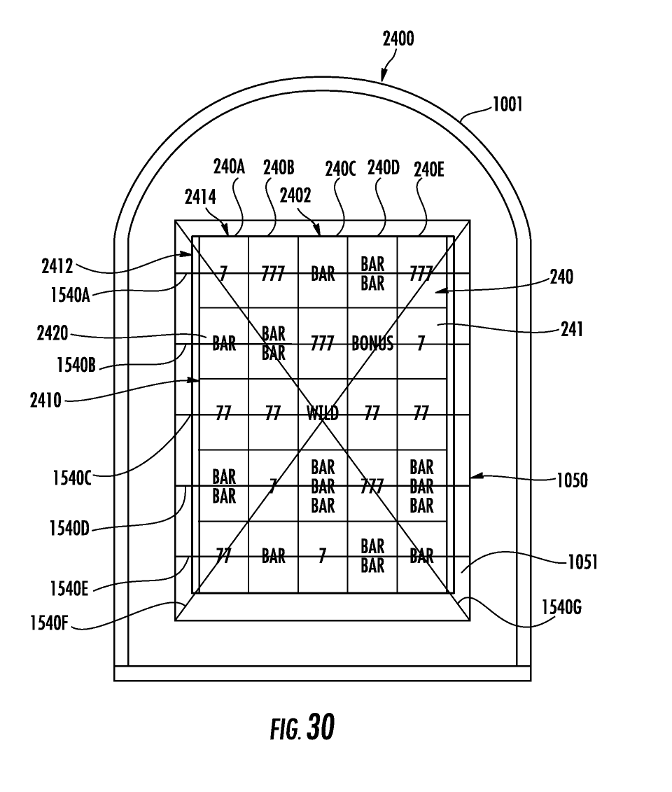

Another method 2900 of operating gaming device 2400 of FIGS. 24-27 is shown in FIG. 29. In method 2900, a player places a wager on gaming device 2400 at step 2802. At step 2804, the game outcome is determined. The game outcome may be determined using a random number generator or may be determined by a random number generator programmed in controller 360 (FIG. 26). At step 2806, gaming display device 2402 (FIG. 24) is activated. This may include activation of flexible belts 240A-E (FIG. 24) and touch sensitive transparent organic light emitting display (TOLED) 1050 (FIG. 24). Other lights and sounds may also be activated to make the event more exciting to the player and those around the player, as well as to call attention to the device.

Method 2900 then proceeds to step 2816 where controller 360 directs transparent organic light emitting display 1050 to show a clear or transparent display. At step 2810, controller 360 causes one or more of flexible belts 240A-E to move or rotate. The game player can then view flexible belts 240A-E and indicia 2420 moving through TOLED 1050. The moving flexible belts 240A-E can be stopped in step 2812. Method 2900 then proceeds to step 2808 where controller 360 directs transparent organic light emitting display 1050 to show one or more payline(s). The game outcome is indicated by the combination of pay line 1540 shown on TOLED 1050 and indicia 2420 shown on flexible belts 240A-E. Any prizes or credits won can be awarded to the player in step 2814.

The order of the various steps shown in method 2900 may be altered and rearranged while still indicating a game outcome. For example, the pay line(s) could be displayed while the flexible belts are moving. In this case, step 2808 would be performed after step 2810.

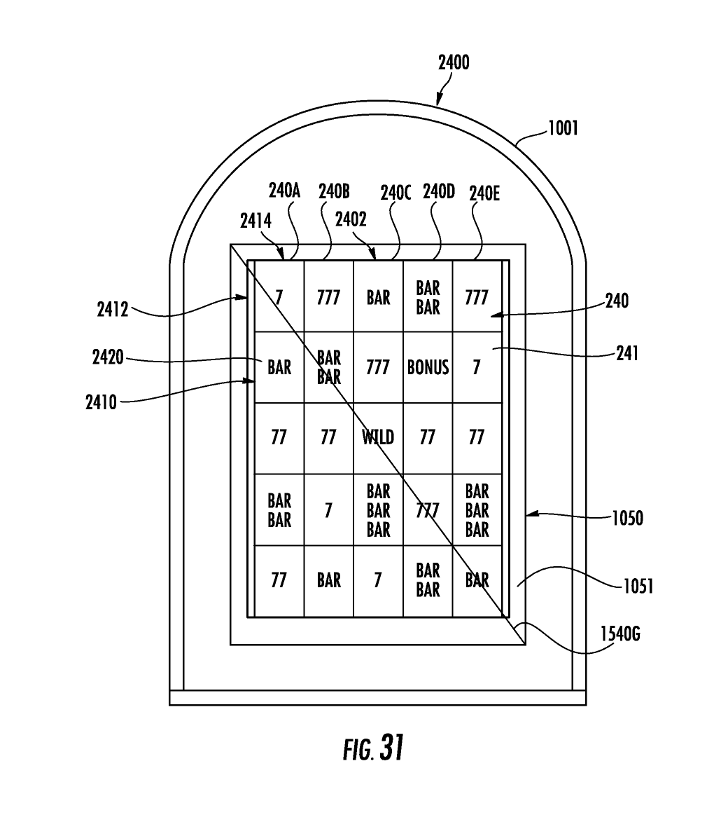

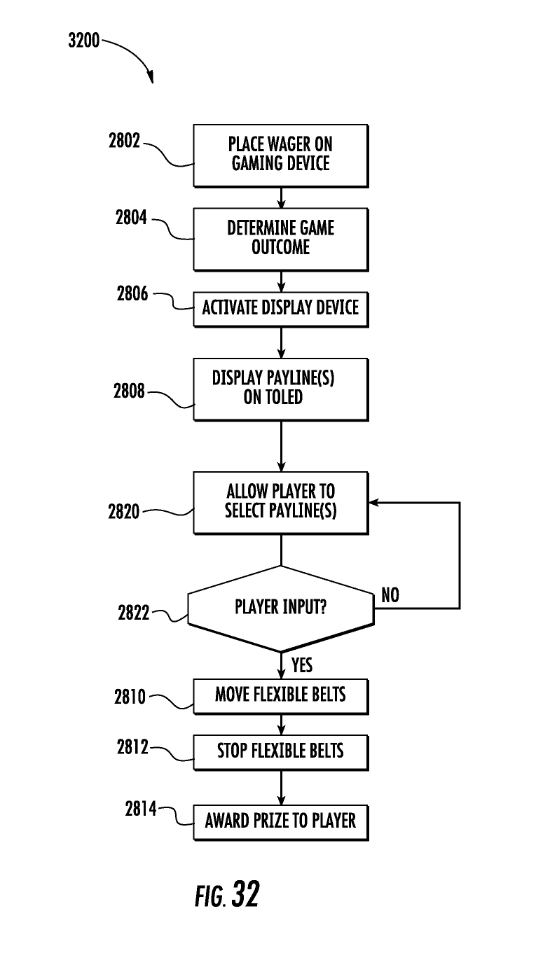

Turning now to FIGS. 30 and 31 another embodiment of gaming device 2400 is illustrated. Touch sensitive transparent organic light emitting display 1050 can serve as a player input device and allow a game player to make a selection or provide input to gaming device 2400 by touching or depressing selected portions of front surface 1051. Alternatively, a separate player input device such as a button could be used. Touch sensitive transparent organic light emitting display 1050 can be used by a game player to select which pay line(s) 1540 indicate a game outcome.

As shown in FIG. 30, initially several pay lines 1540A-G would be shown to the player on TOLED 1050. Pay lines 1540A-G can individually indicate a set of indicia 2420 as a game outcome. The player would then be allowed to select which of the pay lines are active or are used to indicate a game outcome using the touch sensitive transparent organic light emitting display 1050. The player would depress portions of the TOLED front surface 1051 that correspond to the selected pay line(s) desired to be used to indicate a game outcome. After a player selects the pay line(s) to be used, the payline(s) not selected are removed from view and only the selected pay line(s) are shown as illustrated in FIG. 31. In FIG. 31, the player has selected pay line 1540G to indicate the game outcome.

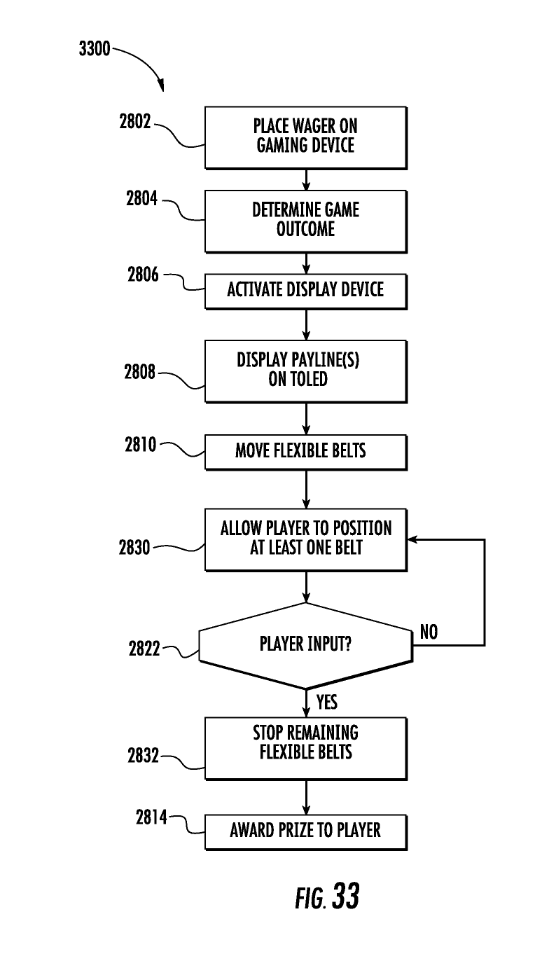

A method 3200 of operating gaming device 2400 of FIGS. 30-31 is shown in FIG. 32. In method 3200, a player places a wager on gaming device 2400 at step 2802. At step 2804, the game outcome is determined. The game outcome may be determined using a random number generator or may be determined by a random number generator programmed in controller 360 (FIG. 26). At step 2806, gaming display device 2402 (FIG. 30) is activated. This may include activation of flexible belts 240A-E (FIG. 30) and touch sensitive transparent organic light emitting display (TOLED) 1050 (FIG. 30). Other lights and sounds may also be activated to make the event more exciting to the player and those around the player, as well as to call attention to the device.

Method 3200 then proceeds to step 2808 where controller 360 directs transparent organic light emitting display 1050 to show pay lines 1540A-G. The player is allowed to select one or more of pay lines 1540A-G in step 2820 by touching the desired pay lines on touch sensitive transparent organic light emitting display (TOLED) 1050. The selected pay lines remain displayed and the non-selected pay lines are hidden.

At decision 2822, method 3200 checks to see if the player has provided input to the gaming device by selecting one or more pay lines. If the player has selected one or more pay lines in step 2820, method 3200 proceeds to step 2810. If the player has not made a selection, method 3200 returns to step 2820 to wait for the player to make a selection.

At step 2810, controller 360 causes one or more of flexible belts 240A-E to move or rotate. The game player can then view flexible belts 240A-E and indicia 2420 moving through TOLED 1050. The moving flexible belts 240A-E can be stopped in step 2812. The game outcome is indicated by the combination of the player selected pay line 1540G (FIG. 31) shown on TOLED 1050 and indicia 2420 shown on flexible belts 240A-E. Any prizes or credits won can be awarded to the player in step 2814.

The order of the various steps shown in method 3200 may be altered and rearranged while still indicating a game outcome. For example, the pay line(s) could be displayed only after they are selected by the player.

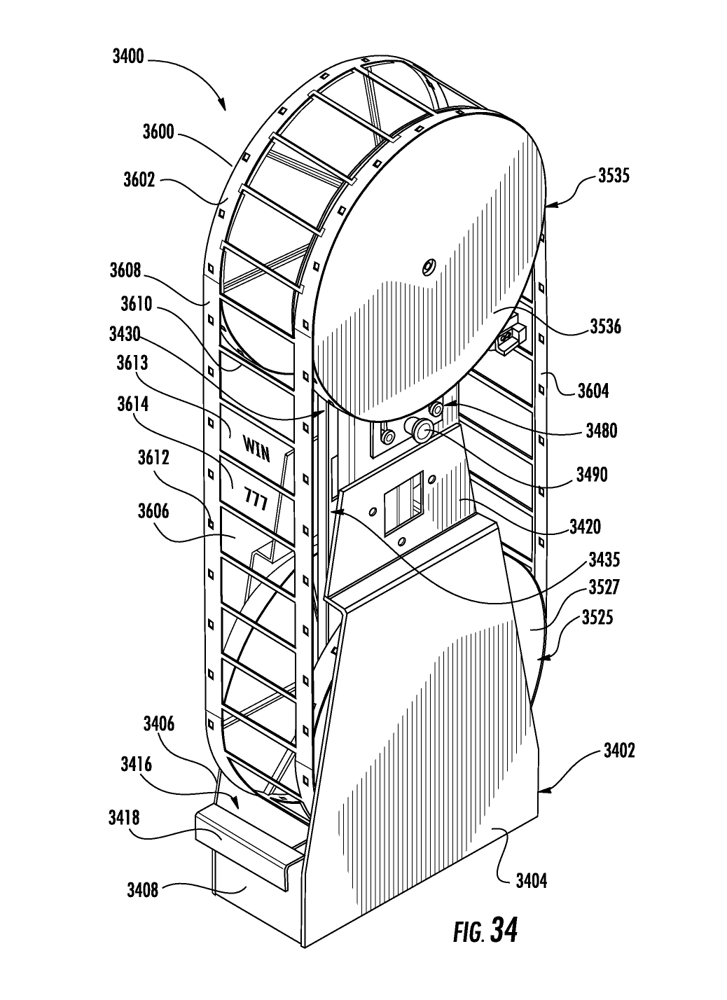

With reference now to FIG. 33, an additional embodiment of a method 3300 of operating gaming device 2400 of FIG. 31 is shown in FIG. 33. In method 3300, a player places a wager on gaming device 2400 at step 2802. At step 2804, the game outcome is determined. The game outcome may be determined using a random number generator or may be determined by a random number generator programmed in controller 360 (FIG. 26). At step 2806, gaming display device 2402 (FIG. 30) is activated. This may include activation of flexible belts 240A-E (FIG. 30) and touch sensitive transparent organic light emitting display (TOLED) 1050 (FIG. 30). Other lights and sounds may also be activated to make the event more exciting to the player and those around the player, as well as to call attention to the device.

Method 3300 then proceeds to step 2808 where controller 360 directs transparent organic light emitting display 1050 to show one or more pay lines such as pay line 1540G. At step 2810, controller 360 causes one or more of flexible belts 240A-E to move or rotate. The game player can then view at least some of flexible belts 240A-E and indicia 2420 moving through TOLED 1050.

At step 2830, the player is allowed to position and stop one or more of flexible belts 240A-E by touching the desired flexible belts to be moved on touch sensitive transparent organic light emitting display (TOLED) 1050. In an example, a player may position and stop flexible belts 240A and 240E. The player may move flexible belts 240A or 240E up by touching display front surface 1051 over flexible belts 240A or 240E and making an upward movement or gesture with their finger. The player may move flexible belts 240A or 240E down by touching display front surface 1051 over flexible belts 240A or 240E and making a downward movement or gesture with their finger. Belts 240A or 240E may stop after the player removes their finger from contact with display surface 1051. Controller 360 receives input from TOLED 1050 and causes flexible belts 240A or 240E to move and stop according to the player input. In another embodiment, a joystick or buttons could be used to allow a player to position flexible belts 240A and 240E.

After flexible belts 240A and 240 have been positioned and stopped, method 3300 proceeds to decision step 2822. At decision 2822, method 3300 checks to see if the player has provided input to the gaming device by positioning one or more of the flexible belts. If the player has positioned the flexible belts in step 2830, method 3300 proceeds to step 2832. If the player has not made a selection, method 3300 returns to step 2830 to wait for the player to complete the positioning of the flexible belts. The remaining moving flexible belts 240B, 240C and 240D can be stopped in step 2832. The game outcome is indicated by the combination of pay line 1540G (FIG. 31) shown on TOLED 1050 and indicia 2420 (FIG. 31) shown on stopped flexible belts 240A-E. Any prizes or credits won can be awarded to the player in step 2814.

The order of the various steps shown in method 3300 may be altered and rearranged while still indicating a game outcome. For example, in one embodiment, a player may be allowed to select both at least one of the pay line(s) to indicate the game outcome and to position at least one of the flexible belts.

Reel Band Assembly Embodiment

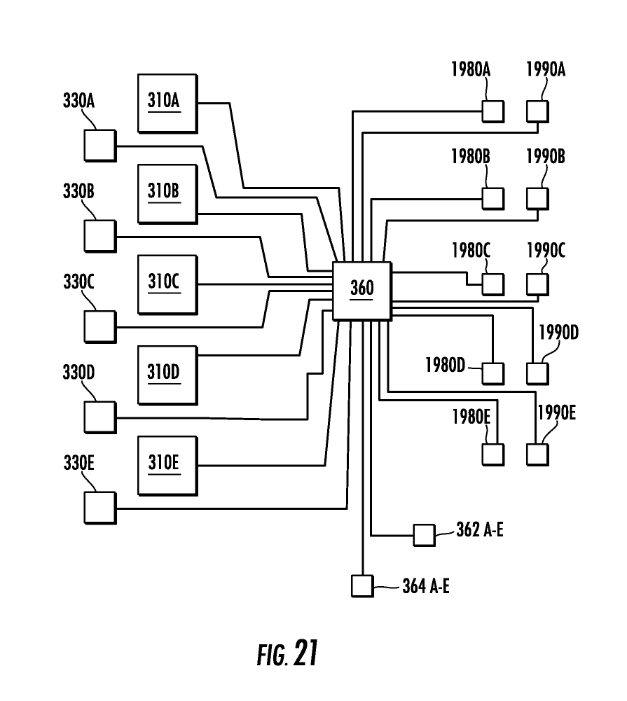

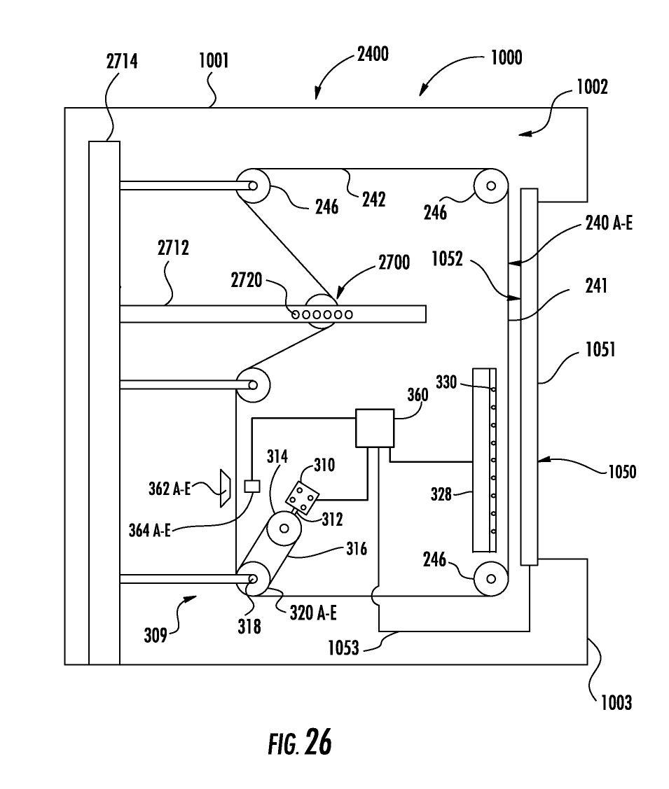

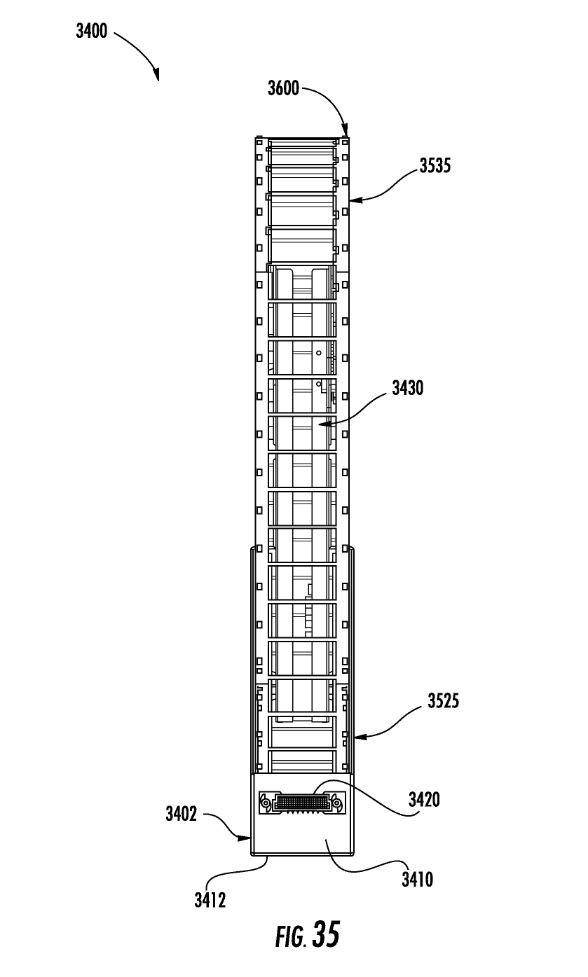

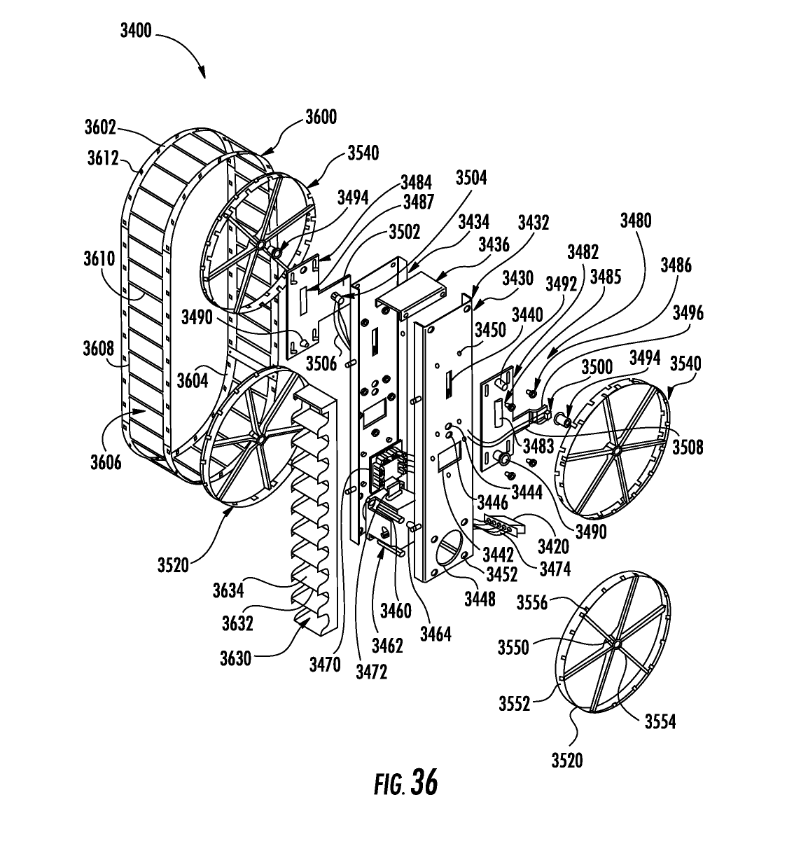

With reference now to FIGS. 34 and 35, a reel band assembly 3400 according to an embodiment of the present invention is shown. Reel band assembly 3400 can replace or augment gaming display device 1900 of FIG. 20 and gaming device 2402 of FIG. 25. Five reel band assemblies 3400 can be placed side by side in a gaming device to replace or augment gaming display device 1900 or gaming display device 2402.

Reel band assembly 3400 can include a housing 3402. Housing 3402 can have a pair of spaced apart side walls 3404 and 3406 and a pair of spaced apart front 3408 and back 3410 walls. Housing 3402 has a bottom wall 3412. Walls 3404, 3406, 3408, 3410 and 3412 define a cavity 3416. A handle 3418 can be attached to front wall 3408. An electrical connector 3420 can be mounted to back wall 3410. Electrical connector 3420 can supply power and data signals to reel band assembly 3400 when connected with another connector (not shown) in a gaming device. A pair of mounting plates 3420, extend from side walls 3404 and 3406, respectively.

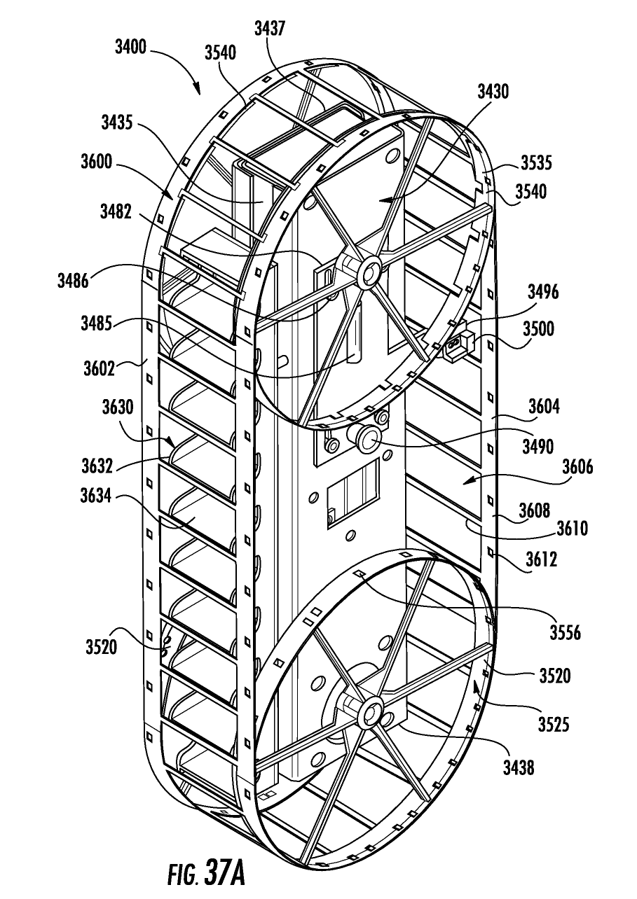

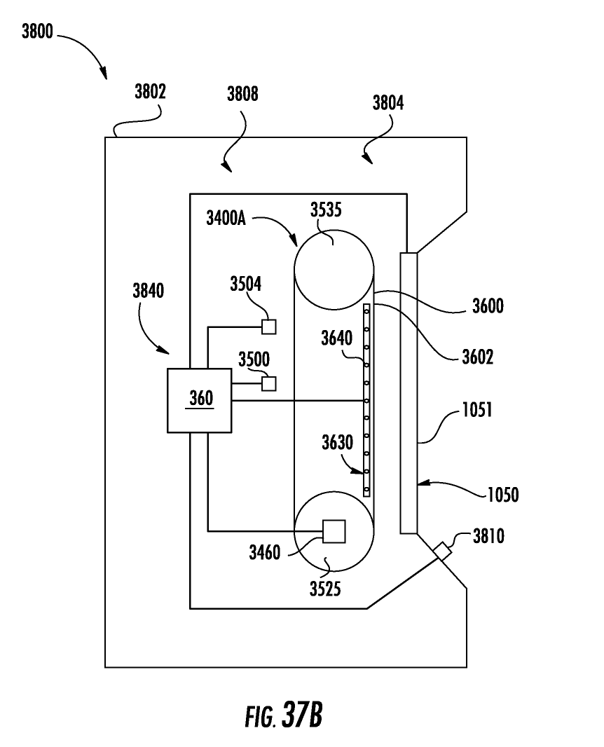

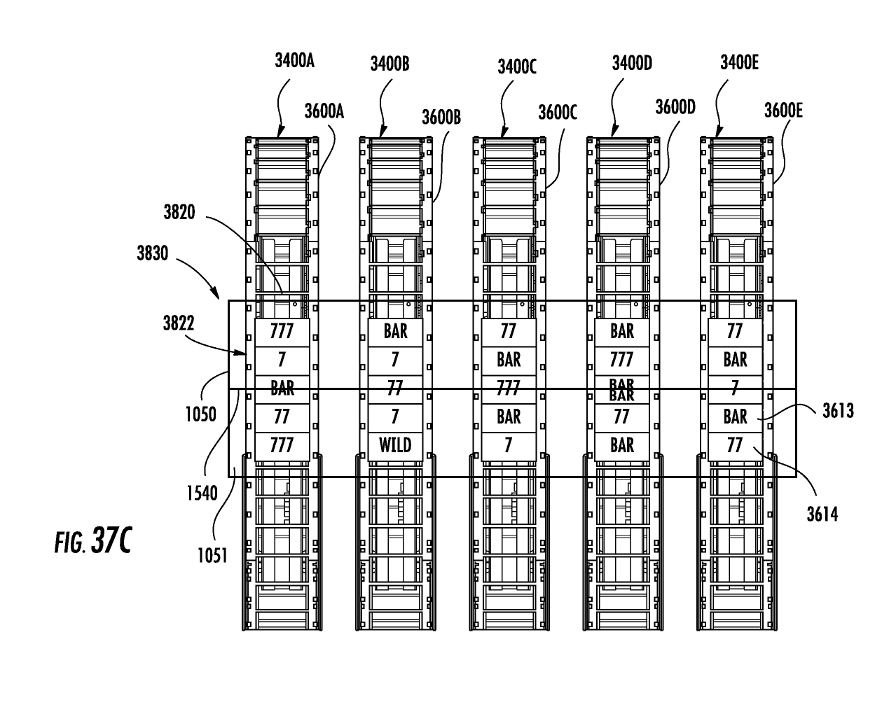

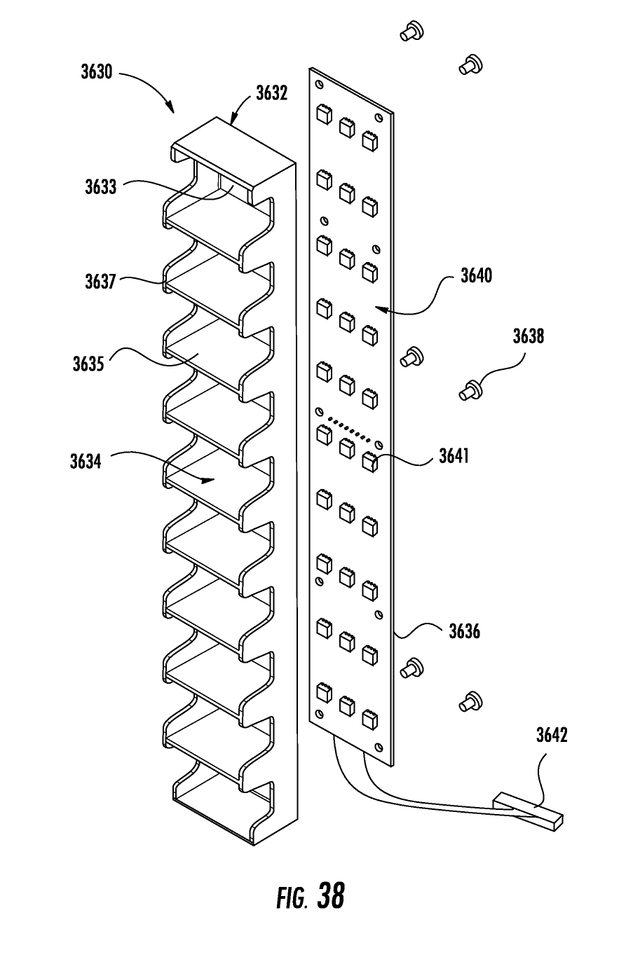

With additional reference now to FIGS. 36 and 37A, reel band assembly 3400 can further include a frame 3430. Frame 3430 can comprise a pair of spaced apart U-shaped plates 3432 and 3434 and a top plate 3436. A cavity 3435 is defined within frame 3430 between plates 3432 and 3434. Frame 3430 has a top end 3437 and a bottom end 3438. Plates 3432, 3434 and 3436 can be formed from metal and can be joined together by a suitable method such as welding or riveting to form frame 3430. Plates 3432 and 3434 each have opposing slots 3440, openings 3442 and apertures 3444, 3446, 3448, 3450 and 3452.

A stepper motor or actuator 3460 can be retained between plates 3432 and 3434 by standoffs 3462. Standoffs 3462 can be fastened or press fit in apertures 3452. Actuator 3460 has an output shaft 3464 that extends through the stepper motor and through both of apertures 3448. Printed circuit board 3470 can be mounted to plate 3434. Printed circuit board 3470 can contain an electronic circuit to drive and control stepper motor 3460 and can contain electronic circuits to enable communication with other portions of a gaming device. An electrical cable 3472 can connect stepper motor 3460 to printed circuit board 3470. Another electrical cable 3474 can connect connector 3420 to printed circuit board 3470.

A reel tensioning assembly 3480 is mounted to frame 3430. Tensioning assembly 3480 comprises a tensioning plate 3482 moveably mounted to plate 3432 and a tensioning plate 3484 moveably mounted to plate 3434. Both tensioning plates each have 4 elongated slots 3482 located toward the corners of plates 3432 and 3434 and a central slot 3483. Tensioning plates 3482 and 3484 can be moveably retained to plates 3432 and 3434 by shoulder screws 3486. Shoulder screws 3486 extend through slots 3482 and are retained in threaded apertures 3450.

A spring 3485 is mounted in both slots 3483 and 3440 of plate 3432. Another spring 3487 is mounted in both slots 3483 and 3440 of plate 3434. Springs 3485 and 3487 bias tensioning plates 3482 and 3484 upwardly or away from stepper motor 3462. Pins 3490 can be used to retain the tensioning plates in an extended or retracted position. When pins 3490 are inserted into apertures 3444, tensioning assembly 3480 is locked into an extended position. When pins 3490 are inserted into apertures 3446, tensioning assembly 3480 is locked into a retracted position.

Spindles 3492 extend outwardly from tensioning plates 3482 an 3484, respectively. Spindles 3492 support bearings 3494. Bearings 3494 are mounted over spindles 3492. Arm 3496 extends away from tensioning plate 3482. An optical sensor 3500 can be mounted to arm 3496. Optical sensor 3500 can sense the position of the rotating band. An electrical cable 3508 connects optical sensor 3500 to printed circuit board 3470.

An arm 3502 extends away from tensioning plate 3484. Another optical sensor 3504 can be mounted to arm 3496. Sensor 3504 can sense a sudden jolt or movement of the reel assembly and send a signal indicating that a “TILT” event has occurred. An electrical cable 3506 connects optical sensor 3504 to printed circuit board 3470.

A pair of circular rims 3520 can form driven reel 3525 and another pair of circular rims 3540 can form idler reel 3535. Rims 3520 and 3540 are circular in shape and each have a central hub 3550, a flat outer wall 3552 and spokes 3554 that extend between hub 3550 and outer wall 3552. Tangs 3556 are arranged around rims 3520 and 3540 and extend outwardly from outer wall 3552. Reel side cover 3536 can be mounted to each side of reel 3535. Reel side cover 3527 can be mounted to each side of reel 3525.

An elongated reel band 3600 may display game indicia 3614. Reel band 3600 is continuous or endless and can be made from a suitable material such as rubber, plastic or metal. Reel band 3600 comprises an outer display surface 3602, an inner surface 3604, several individual frames 3606, rails 3608, cross-members 3610 and holes 3612. Cross-members 3610 are perpendicular to rails 3608. A number of planar panels 3613 can be mounted to rails 3608 and cross-members 3610, covering frames 3606 on display surface 3602. Indicia 3614 can be located on panels 3613. Panels 3613 can be formed from a flexible material that is at least partially transparent. Panels 3613 can be mounted to reel band 3600 by any suitable means such as by using fasteners or adhesives. In other embodiments, panels 3613 can be replaced by a continuous belt that covers reel band 3600. Holes 3612 are defined in rails 3608.

Reel band 3600 can be mounted over reels 3525 and 3535 such that inner surface 3604 is in contact with outer wall 3552 and tangs 3556 are engaged with and extend through holes 3612.

Reel band 3600 can be rotated or moved by an actuator 3460. Actuator 3460 can rotate driven reel 3525 which in turn moves reel band 3600. Actuator 3460 can be in communication with a controller (not shown). Actuator 3460 can move and stop reel band 3600. In this manner, indicia 3614 can be moved or positioned in a gaming device.

Reel tensioning assembly 3480 can move and adjust the tension of reel band 3600. Springs 3485 and 3487 bias idler reel 3535 away from driven reel 3525. Pins 3490 can be used to retain the tensioning plates in an extended or retracted position. When pins 3490 are inserted into apertures 3444, tensioning assembly 3480 is locked into an extended position. When pins 3490 are inserted into apertures 3446, tensioning assembly 3480 is locked into a retracted position.

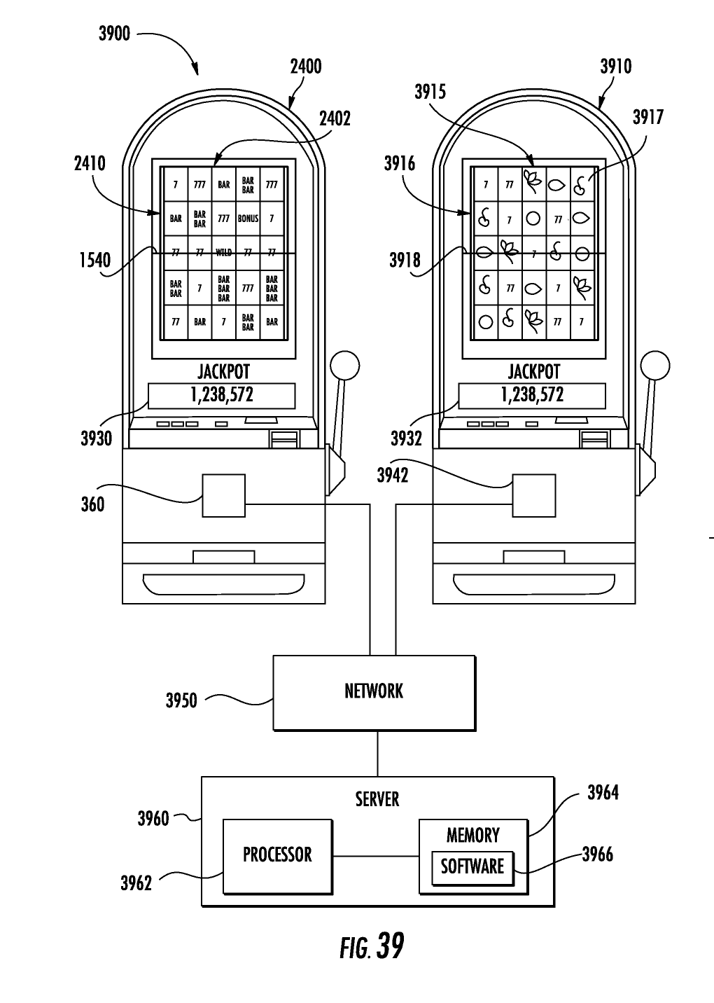

A light assembly 3630 can be mounted to frame 3430. Panels 3613 can be at least partially transparent and can be backlit by light assembly 3630 such that the visibility of indicia 3614 is enhanced. With additional reference to FIG. 38, light assembly 3630 may include a rectangular shaped housing 3632 with individual compartments 3634. Housing 3634 has a pair of generally parallel spaced apart side walls 3637. Separation walls 3635 extend perpendicularly away from and between side walls 3637 and define individual compartments 3634. An opening 3633 is defined at the rear of each compartment 3634.

A matrix 3640 of light emitting diodes (LEDs) 3641 can be mounted to a printed circuit board 3636. Fasteners 3638, such as rivets or screws, can be used to attach printed circuit board 3636 to housing 3632. Electrical cable 3642 electrically connects printed circuit board 3636 to printed circuit board 3470 in order to supply power to LEDs 3640. When an individual row of LEDs 3640 are illuminated within an individual compartment 3634 and illuminate an individual panel 3613, separation walls 3635 and side walls 3637 prevent light from leaving one of the compartments 3634 and illuminating any adjacent panels 3613.

With reference now to FIGS. 37A, 37B and 37C, a gaming device 3800 using five reel band assemblies 3400 is shown. Gaming device 3800 has a housing 3802 with an internal cavity 3804. Gaming device 3800 can have a display device 3808 that allows a player to play a game. Gaming device 3800 can be a primary game that operates alone or can be a bonus game.

Gaming display device 3808 can include five reel assemblies 3400A, 3400B, 3400C, 3400D and 3400E with reel bands 3600A, 3600B, 3600C, 3600D and 3600E. Reel bands 3600A-E are each moved, positioned or rotated by an actuator 3460, only one of which is shown in FIG. 37B. Each reel band contains game indicia 3614 mounted to panels 3613. Reel assemblies 3600A-E can be positioned adjacent to each other in housing 3802 such that columns 3820 and rows 3822 form a 5×5 matrix 3830. Each of the reel bands has an outer display surface 3602.

Game indicia 3614 can be arranged into five rows 3822 and five columns 3820. More or fewer rows and columns could be used. Game indicia 3614 can contain a wide variety of indicia that are attractive to a game player. For example, game indicia 3614 may include letters, words, numbers, symbols, pictures, images, objects or avatars.

Each individual reel band 3600A-E can be rotated or moved by a positioning mechanism 3840. Positioning mechanism 3840 comprises actuators 3460, driven reels 3525 and idler reels 3535. Reel bands 3600A-E can be rotated by actuators 3460A-E.

Actuators 3460A-E can be in communication with controller 360. Controller 360 can control and select the movement and position of each of reel bands 3600A-E. The position of reel bands 3600A-E can be monitored by controller 360 using a position sensor 3500. Controller 360 is also in communication with a tilt sensor 3504 that can detect tampering of the gaming device.

Controller 360 can select the game indicia 3614 that is shown or displayed to the game player. Controller 360 can select the row 3822 of game indicia that are displayed on pay line 1540. As the reel bands 3600A-E are rotated, the game player can view the possible game outcomes. Pay line 1540 can indicate a game outcome. The five game indicia 3614 indicated by pay line 1540 can indicate a game outcome.

Gaming device 3800 and display device 3808 can include a transparent touch sensitive display, or transparent touch screen such as a transparent touch sensitive organic light emitting display (TOLED) 1050. A TOLED device may also be referred to as transparent organic light emitting diode display. Transparent organic light emitting display 1050 can be mounted to housing 3802 and cover at least a portion of reel bands 3600A-E.

A game player playing gaming device 3800 would face and view front surface 1051. Because TOLED 1050 is transparent the indicia 3614 of reel bands 3600A-E are readily viewable by the game player.

A transparent organic light emitting display is a flexible full-color flat-panel display with a level of brightness, viewing angle, and sharpness that is not possible with traditional flat-panel displays. Transparent organic light emitting displays are transparent except for the areas or sections of the display that are energized and actively showing images. Transparent organic light emitting displays are flexible, thin and lightweight making them well suited for a variety of applications. Transparent touch sensitive organic light emitting displays are commercially available.

Transparent organic light emitting displays have a unique distinct look that can attract attention to the gaming device. In addition, the transparent organic light emitting display can offer the gaming operator more choices of symbols to be displayed and possible game outcomes. A TOLED is constructed on a transparent substrate through which the light emitted by the device is viewed, and the device structure typically includes, in sequence, the transparent substrate, a transparent conductive hole-injecting electrode, an organic hole-transporting layer, an organic light-emitting layer, an organic electron-transporting layer and an electron-injecting electrode (cathode) consisting of a metal having a low work function. A TOLED converts electric energy into light energy. TOLED technology incorporates organic luminescent materials that, when sandwiched between electrodes and subjected to a DC electric current, produce intense light of a variety of colors. These TOLED structures can be combined into the picture elements or pixels that comprise a display.

A TOLED can be manufactured to be top-only emitting, bottom-only emitting, or both top and bottom emitting. A display using TOLED technology can greatly improve contrast, making it much easier to view displays in bright sunlight.

Controller 360 can be in communication with TOLED 1050. Controller 360 can present or display a wide variety of images, symbols, video presentations or indicia on TOLED 1050.

Controller 360 can selectively provide signals to a matrix of X and Y coordinates in TOLED display 1050 to create the desired image. Controller 360 can selectively turn areas of TOLED 1050 from clear or transparent to opaque and likewise can turn areas that are opaque to transparent.

Software in conjunction with known display controller technology is used to store a pattern of bits in a memory corresponding to the image to be displayed. One possible display may be a raster scan that selectively energizes the TOLED display by rows and columns at a rapid rate.

Panels 3613 can be backlit by light assembly 3630 using light emitting diodes 3640 that are positioned behind panels 3613. Panels 3613 can be partially transparent such that indicia 3614 can be backlit. Lights 3640 are in communication with and can be controlled by controller 360. Lights 3640 can be turned on and off or flashed in a sequence when a game event has occurred. For example, the lights that are behind the indicia 3614 that correspond with a pay line 1540 award can be illuminated.

In an embodiment, TOLED 1050 may initially present no images and be transparent. Reel bands 3600A-E can rotate causing indicia 3614 to move in a vertical direction. Indicia 3614 can be moved from top to bottom or from the bottom to the top of rows 3822. Because TOLED 1050 is transparent, a game player viewing TOLED 1050 would see indicia 3614 moving up or down through TOLED 1050. TOLED 1050 can display one or more pay lines 1540. Pay line 1540 can indicate a set of indicia 3614 as a game outcome. While one pay line 1540 is shown a wide variety of pay lines can be shown across matrix 3830 in various directions such as vertical, horizontal, diagonal or random. Pay lines 1540 can be shown in a wide variety of colors and styles that are attractive to casino patrons.

After a period of time, the rotation of reel bands 3600A-E can be stopped by controller 360. A game outcome can be indicated by the combination of indicia 3614 and payline 1540 shown or displayed on TOLED 1050. Any prizes won can be awarded and added to the player's credit meter. The indicia 3614 could further be indicated as a game outcome by illuminating backlights 3640.

In an embodiment, gaming device 3800 can include a player input device 3810 mounted to housing 3802 and is in communication with controller 360. Player input 3810 can be a button, joystick, touch screen or any other suitable player input device. Player input device 3810 can allow a game player to at least partially control the position of one or more reel bands 3600A-E. In an embodiment, the game player can be allowed to select the final stopping position of one of reel bands 3600A-E. Methods 2800 of FIG. 28 and 2900 of FIG. 29 can be used in the same manner with gaming device 3800 with reel assemblies 3400A-E replacing flexible belt assemblies 240A-E.

In another embodiment, player input device 3810 can allow a game player to select one or more paylines 1540 to display a game outcome on TOLED 1050. Methods 3200 of FIG. 32 and 3300 of FIG. 33 can be used in the same manner with gaming device 3800 with reel assemblies 3400A-E replacing flexible belt assemblies 240A-E.

Progressive Gaming Embodiment

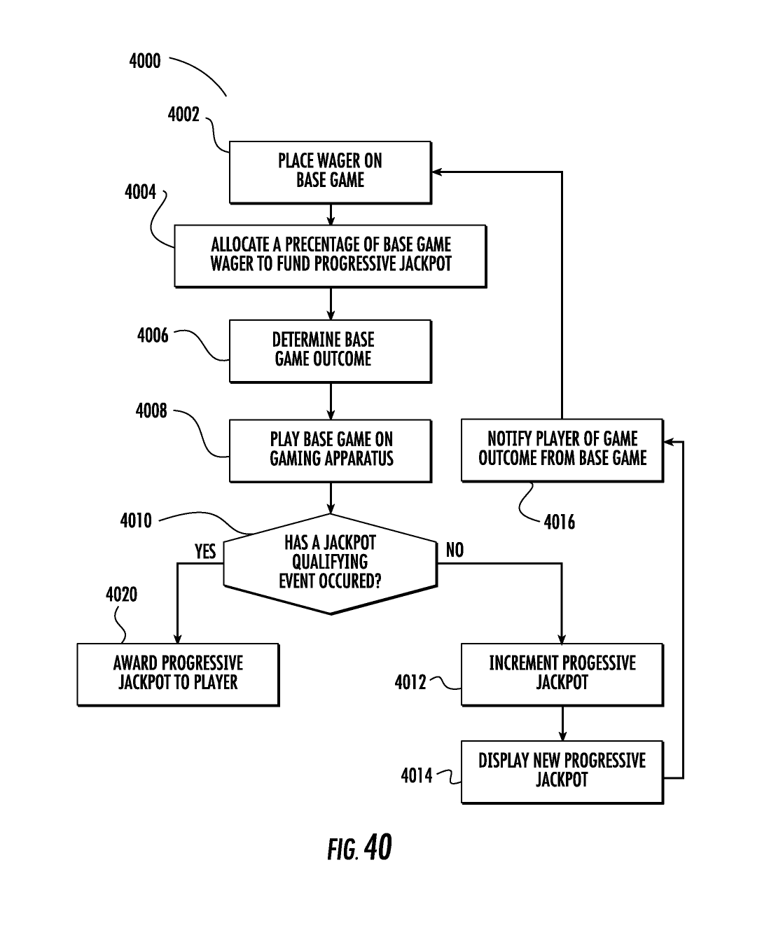

With reference now to FIG. 39, a progressive gaming system 3900 according to another embodiment of the present invention is shown. Progressive gaming system 3900 comprises a computer server 3960 that is in communication with several gaming apparatuses or devices 2400 and 3910 through a communication network 3950. Progressive gaming system 3900 can accept wagers from multiple gaming devices and administer one or more games that allow a player to play for a progressive jackpot.

Progressive gaming system 3900 can include several gaming devices such as gaming devices 2400 and 3910. Gaming devices 2400 and 3910 can be located in the same location or may be remote from each other. For example, gaming device 2400 may be in Las Vegas, Nev. and gaming device 3910 may be in Atlantic City, N.J. While two gaming devices are shown, more or less can be used. Gaming device 2400 has a controller or processor 360 that at least partially controls the operation of gaming device 2400. Gaming device 3910 has a controller or processor 3942 that at least partially controls the operation of gaming device 3910. Processors 360 and 3942 can at least partially store and maintain a paytable that determines the payouts and awards that occur when gaming devices 2400 and 3910 are played by a game player.

Processors 360 and 3942 may be in communication with a communication network 3950. Communication network 3950 can be a local area network (LAN), wide area network (WAN), wireless network or an internet network. Network 3950 can be in communication with a computer server 3960. Server 3960 may be any suitable server or computing device which includes at least one processor 3962 and a memory, computer readable medium or storage device 3964. Processor 3962 can be a conventional micro-processor and storage device 3964 may be random access memory or hard disk drives. Software 3966 can be stored on computer readable medium or memory 3964 and operate on processor 3962 in order to implement progressive gaming system 3900. In one embodiment, software 3966 contains progressive jackpot software programs and instructions that are executable by processor 3962 in order to at least partially fund and determine the payout of a progressive jackpot. Server 3960 can collect and transmit game information and instructions between server 3960 and gaming devices 2400 and 3910. For example, server 3950 can apportion a percentage of each wager placed on gaming devices 2400 and 3910 to fund a progressive jackpot.

With continued reference to FIG. 39, gaming device 2400 comprises a five by five matrix mechanical flexible belt gaming display device 2402 and a progressive jackpot display 3930. Server 3960 may transmit the current progressive jackpot that a game player may play for to progressive jackpot display 3930. Progressive jackpot display 3930 can be any suitable display such as a liquid crystal display, a light emitting diode display or a video display. Gaming display device 2402 has a matrix 2410 of game indicia and a payline 1540. The structure and operation of gaming display device 2400 has previously been described with reference to FIGS. 24-26.

Gaming device 3910 comprises a video display device 3915 and a progressive jackpot display 3932. Progressive jackpot display 3932 can be any suitable display such as a liquid crystal display, a light emitting diode display or a video display. Server 3960 may transmit the current progressive jackpot that a game player may play for to progressive jackpot display 3932. Video display device 3915 can be a conventional video display device that can show a matrix 3916 of game indicia 3917 and a payline 3918. The structure and operation of video display device 3915 can be the same a previously described with reference to video display 55 of FIG. 1b.

Conventional slot machines that use mechanical spinning reels are limited in the number of payout occurrences that can be displayed because of the limitations on the number of indicia that are able to be shown on the spinning reel. This causes the paytables associated with a spinning reel mechanism to have a small number of payout options. A flexible belt mechanical display device 2402 of FIG. 39 can carry more indicia and symbols than a conventional round spinning reel. The use of flexible belt mechanical display device 2402 allows a larger number of paytable payout options and greater control over the type and size of prizes that can be awarded. Flexible belt mechanical display device 2402 can be used to award low probability prizes, such as large progressive prizes. Flexible belt mechanical display device 2402 can display the same number of indicia use the same paytable as a video display. Because flexible belt mechanical display device 2402 can display a larger number of indicia and symbols, more unique game outcomes or combinations of symbols can be displayed. A higher percentage of the possible game outcomes can be non-winning outcomes.

Video display gaming device 3910 can award large prizes because the virtual reels can carry any number of indicia and symbols and there are a large number of non-winning combinations that can be displayed. The paytables associated with video display gaming device 3910 can have a number of possible game outcomes. It is desirable for the gaming devices connected to a progressive gaming network to have the same paytable, thereby simplifying the computing overhead associated with collecting progressive contributions and determining the progressive payout. It is advantageous for a gaming device with a mechanical display to have the same paytable as a gaming device with a video display. Progressive game operators need to ensure that each gaming machine in the network has the same probability of hitting a progressive jackpot

Processors 360 and 3942 may include a random number generator. The random number generator produces a random or pseudo random number for each game. The outcome of the game may be determined by comparing the random number to a table of outcomes or paytable that is stored in a memory of processors 360 and 3942. Server 3960 can communicate with processors 360 and 3942 and be programmed with software 3966 to administer a progressive jackpot game.

In one embodiment of the present invention a progressive paytable such as paytable A below may reside in software 3966 of server 3960 and be used with both gaming devices 2400 and 3910. The progressive jackpot parameters can be the same for all the gaming devices connected to progressive gaming system 3900. The prize associated with a progressive jackpot and the odds of winning the progressive jackpot can be the same for all gaming devices connected to progressive gaming system 3900. Playing for a progressive jackpot is contingent upon the placement of a minimum bet requirement by a game player.

Paytable A

| Progressive Parameters | |
|---|---|
| Denomination | $0.01 |
| Bet Requirement | $1.25 |
| Average Pay | $200,000.00 |
| Reset Amount | $100,000.00 |
| Reset Percent | 1.00% |
| Incrementation Percent | 1.00% |
| Hit Frequency 1 in: | 8,000,000 |
| | Base Games |
| Hit Probability | 0.000000125 |
| | Per Base Game |
| Game Parameter | |
| Big Bonus Entry | 0.01408046 |
| Probability | Per Base Game |
| Big Bonus Hit Frequency | 71.02040816 |
| | Base Games |
| Probability of Progressive | 0.000888% |
| per Bonus Entry | |
| Games per Progressive | 112643.6782 |

In an embodiment, a game player playing gaming devices 2400 or 3910 first qualifies for bonus game play by obtaining a bonus chance. The probability of playing the bonus game is 0.01408046 for each base game that is played on the gaming devices. Another way to state this probability is that the bonus game is entered once for every approximately 71 base games played. A bonus game can then be played by a game player on gaming devices 2400 or 3910. The bonus game includes a chance to win a progressive prize. The probability of winning a progressive jackpot from a bonus game is 0.000888% for each bonus game that is played on the gaming device. Another way to state this probability is that the progressive jackpot is awarded or won once for every approximately 112,644 bonus games played.

In other embodiments, a game player may qualify for a progressive jackpot award directly from a base game without entry into a bonus game. The overall probability of winning a progressive jackpot from a base game is 1 in every 8,000,000 base games played.

With reference to FIGS. 39 and 40, a flowchart of a method of game play 4000 using progressive gaming system 3900 is shown. At step 4002, a player may initiate game play method 4000 by placing a wager one of gaming devices 2400 or 3910. The wager may be in form of cash or credit from actual domestic or foreign currency, vouchers, coupons, tickets, electronic cards, and other sources or forms of wagers known in the art. At step 4004, server 3960 and processors 360 and 3942 may allocate a percentage of the wager such as 2% to fund a progressive jackpot. Once the player initiates game play, server 3960 and/or processors 360 and 3942 may generate a random number and randomly determine the base game outcome at step 4006. Next, the player may play a base or primary game on the gaming device at step 4008.

At decision 4010, server 3930 determines if a jackpot qualifying event has occurred. Server 3960 may be programmed to accomplish this by generating another random number and comparing the random number to a paytable such as paytable A. If the server does not detect a jackpot qualifying event, method 4000 proceeds to step 4012 where the progressive jackpot is incremented. The new progressive jackpot is displayed to the player in step 4014. The player is notified of the game outcome from the base game at step 4016. Method 4000 then returns to step 4002 where the player may place another wager and play again.

If the server 3960 detects a jackpot qualifying event at decision 4010, method 4000 proceeds to step 4020 where the progressive jackpot is awarded.

The steps shown in the flowchart do not necessarily imply that the steps have to take place in a particular order. The order of steps may be varied; some steps may be eliminated; and, some steps may be replaced with other steps. Such variations still fall within the scope of the invention.

### CONCLUSION

It can thus be realized that certain embodiments of the present invention provide a highly attractive and entertaining device for displaying game prizes. Certain embodiments of the present invention further provide a flexible belt that can be used in a game. Thus, certain embodiments of the present invention can easily catch patrons' attention and invite patrons to play the game. Certain embodiments may further cause players to play longer because the display device enhances the anticipation, stimulation, excitement and participation experienced by players.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A gaming apparatus comprising:
(A) a reel assembly having a frame, the frame having a first end and a second end;
(B) a driven reel coupled to the first end;
(C) an idler reel coupled to the second end;
(D) a reel band coupled to the driven and idler reels, the reel band having a display surface;
(E) a plurality of indicia located on the display surface; and
(F) an actuator mounted to the frame and coupled to the driven reel, the actuator configured to drive the driven wheel to move the reel band.

2. The gaming apparatus of claim 1, wherein a plurality of at least partially transparent panels are mounted to the reel band, the indicia located on the panels.

3. The gaming apparatus of claim 2, further comprising a light assembly coupled to the frame and positioned adjacent the reel band to illuminate at least one panel.

4. The gaming apparatus of claim 1, wherein a plurality of the reel assemblies are mounted adjacent each other to form a matrix of indicia.

5. The gaming apparatus of claim 4, further comprising an input device in communication with the actuator, the input device adapted to allow a player to position at least one of the reel bands.

6. The gaming apparatus of claim 1, further comprising a tensioning mechanism mounted between the frame and the idler reel for tensioning the reel band.

7. The gaming apparatus of claim 1, wherein the frame has a cavity, the actuator mounted in the cavity.

8. The gaming apparatus of claim 1, wherein a transparent light emitting display is mounted adjacent the reel assembly such that the reel assembly can be viewed through the transparent light emitting display.

9. The method of claim 1, further comprising displaying a progressive jackpot on a video display in association with the reel assembly.

10. A method of gaming not necessarily in the order shown, comprising:
(A) allowing a player to place a wager;
(B) determining a game outcome;
(C) moving a plurality of reel bands, each of the reel bands coupled to a driven reel that is adapted to rotate the respective reel band, each of the reel bands having a display surface and each of the display surfaces having a plurality of indicia thereon;
(D) stopping the reel bands; and
(E) indicating a set of the plurality of indicia as the game outcome.

11. The method of claim 10, further comprising allowing the player to position at least one of the reel bands.

12. The method of claim 10, further comprising allowing a player to select at least one pay line using a transparent light emitting display mounted adjacent the reel bands.

13. The method of claim 10, further comprising displaying a progressive jackpot in association with the reel bands.

14. A gaming apparatus comprising:
(A) a plurality of reel assemblies positioned adjacent each other, each of the reel assemblies having a reel band that is coupled to a driven reel, each of the reel bands having a display surface;
(B) a plurality of indicia disposed on each of the display surfaces;
(C) a plurality of actuators, each of the actuators being coupled to one of the driven reels, respectively; and
(D) a controller in communication with the actuators, the controller being configured to:
(a) determine a game outcome;
(b) cause one or more of the plurality of actuators to move one or more of the reel bands; and
(c) stop the one or more of the reel bands such that a set of the indicia form a game outcome.

15. The gaming apparatus of claim 14 wherein a tensioning mechanism is coupled to at least one the reel assemblies.

16. The gaming apparatus of claim 14, further comprising an input device in communication with the controller, the input device adapted to allow a player to position at least one of the reel bands.

17. The gaming apparatus of claim 14, further comprising a frame having a first and second end, the driven reel coupled to the first end and an idler reel coupled to the second end.

18. The gaming apparatus of claim 14, wherein a transparent light emitting display is mounted adjacent the reel assemblies such that the reel assemblies can be viewed through the transparent light emitting display.

19. A gaming apparatus comprising:
(A) reel band means for displaying a plurality of indicia;
(B) reel means for supporting the reel band means for rotating movement;
(C) actuator means for moving the reel band means, the actuator means being coupled to the reel means; and
(D) controller means for controlling the actuator means, the controller means being in communication with the actuator means, the controller means being configured to cause the actuator means to move the reel band means such that at least one of the indicia convey a game outcome.

20. The gaming apparatus of claim 19, wherein the reel means comprises a frame having a first end and a second end, a driven reel coupled to the first end and an idler reel coupled to the second end.

21. The gaming apparatus of claim 19, wherein the reel band means comprises a reel band having a display surface, at least one panel mounted to the reel band, the indicia located on the panel.

22. The gaming apparatus of claim 19, further comprising tensioning means coupled to the reel means for adjusting the tension the reel band means.

23. The gaming apparatus of claim 19, further comprising player input means in communication with the controller means.

24. The gaming apparatus of claim 19, wherein the indicia are backlit by a light assembly.
